(19) United States
(12) Patent Application Publication
(10) Pub. No.: US 2013/0238903 A1
(43) Pub. Date: Sep. 12, 2013

(54) SERVICE PROVISION METHOD

(71) Applicant: Takeshi Mizunuma, Sagamihara (JP)

(72) Inventor: Takeshi Mizunuma, Sagamihara (JP)

(21) Appl. No.: 13/808,100

(22) PCT Filed: Jul. 9, 2010
(86) PCT No.: PCT/JP2010/004482

§ 371 Date: May 16, 2013

(51) Int. Cl. H04L 9/32

(52) U.S. Cl. CPC H04L 9/3247
USPC 713/176

(57) ABSTRACT

A method of providing a service from a service provider to users is described. The method comprises: a step of generating an electronic signature on a first information provided by a user with a secret key of the service provider and providing the electronic signature to the user, a step of receiving a request for the service together with information identifying the first information item from a user and accepting this request if it is justifiable; a step of receiving, if the request is accepted, a second information item from the user; a step of determining whether or not there is a predetermined relationship between the first information item and the second information item; and a step of performing, if there is the predetermined relationship, a necessary procedure for providing the service by the use of an information processing device; and a step of saving the second information item even after providing the service as an evidence that the service has been provided.

### TECHNICAL FIELD

This invention relates to a service provision method, and more particularly to a service provision method having high security and reliability through the Internet.

### BACKGROUND ART

When the Internet is used, there are always risks of impersonation, eavesdropping, data tampering and so forth. The use of encryption is an effective technique against such fraud. Particularly, PKI (Public Key Infrastructure) is a critical technique for safely using the Internet, including SSL (Secure Socket Layer).

On the other hand, although not directly using the Internet, in recent years, electronic money implemented within an IC card is widely distributed by reinforcing the security on the basis of encryption. Ecash™ is a scheme of electronic money using encryption on the Internet developed by DigiCash. A certain degree of anonymity is introduced in Ecash by using a blind signature rather than the usual PKI technique. However, the number of users did not increase because of requiring accounts opened in an allied bank and cumbersome procedure, resulting in failure.

There are other network-type electronic money schemes proposed by using encryption, and most of them have not achieved a successful outcome. Generally speaking, network-type electronic money schemes currently used are schemes in which monetary values are carried only on prepaid numbers which are issued when purchasing electronic money. An example is described in Patent Document 1. Such electronic money is not based on encryption, but based only on relations of trust between the issuer and users.

### CITATION LIST

### Patent Literature

PTL 1: Japanese Patent Published Application No. 2006-318502

### SUMMARY OF INVENTION

### Technical Problem

If a service is provided through the Internet without client authentication or encryption, a certain number of troubles cannot be avoided. For example, some customers are complaining that electronic money balance has decreased even though no goods (service) have been purchased. It is fairly difficult to make clear the fact, i.e., the reason for which the problem has occurred, for example, user's faulty memory, user's negligence in preventing the leakage of electronic money information, malfunction in the system, hacking attack, or the like. Namely, it is difficult to clarify where responsibility lies and persuade the user alleging a loss.

For example, in the case of “Net Cash” (provided by NTT Card Solution Corporation), it was found in 2006 by general inquiries that prepaid numbers had been leaked and illegally used (Internet resource URL: http://www.ntt-card.co.jp/company/news/39.html). In this example, it was ascertained by analyzing the access log that prepaid numbers had been leaked from the server. However, in the case of user's faulty memory or false claim, it is difficult to ascertain the fact. Particularly, when using electronic money on an anonymous basis, the user may give up raising an objection after hesitation, even encountering trouble. Nevertheless, most network-type electronic money schemes are operating without client authentication or encryption. This is because the advantages of introduction of client authentication or encryption cannot exceed the disadvantages (introduction cost, low usability or the like).

On the other hand, in spite of the fundamental potential, PKI have spread only in one direction, at least at the individual level. Namely, a corporation as a service provider has a public key certificate and electronically signed information relating to its service, and general individual users confirm the certificate and use the service. Basically speaking, if individual users have public key certificates and use electronic signatures, there is a possibility that the range of service is expanded. However, such usage is exceptional.

In fact, individuals use electronic certificates in only a limited number of cases. This seems because the introduction of PKI is cumbersome. At the present time, when it become indispensable, an individual files an application with a certificate authority and obtains his electronic certificate by taking the necessary steps. This is not only cumbersome but also costly. Also, it is needed to pay attention to the effective period. Furthermore, the electronic certificate is used to personally identify the user as an individual so that it is important to deliberately handle the electronic certificate, like handling a personal seal. In some respects, the electronic certificate serves to identify the user as an individual in a more direct manner than a personal seal, so that the risk of misuse may be higher when it is leaked.

It is therefore an object of the present invention to realize a method of providing a high security service with a minimum risk and a minimum implementation/operation cost.

### Solution to Problem

In order to accomplish the object as described above, the present invention provides a method of providing a service from a service provider to users comprising the following elements. Namely, the method comprises: a step of receiving a first information item provided by a user by an information receiving device; a step of generating an electronic signature on the first information with a secret key of the service provider by the use of an information processing device and providing the electronic signature to the user, a step of receiving a request for the service together with information identifying the first information item from a user and accepting this request if it is justifiable; a step of receiving, if the request is accepted, a second information item transmitted from the user by an information receiving device; a step of determining whether or not there is a predetermined relationship between the first information item and the second information item by the use of an information processing device; and a step of performing, if there is the predetermined relationship, a necessary procedure for providing the service by the use of an information processing device; and a step of saving the second information item even after providing the service as an evidence that the service has been provided, wherein the request for the service is judged that it is not justifiable in the case where the second information item identified by the information which is received together with this request has been received and saved, and the service has already been provided, wherein, from the viewpoint of the current information processing technology, it is considered generally impossible to generate information having the predetermined relationship with the first information item in advance of knowing the second information item.

Of the above elements, there are the following examples as the combination of the first information item and the second information item such that it can be determined “whether or not there is a predetermined relationship between the first information item and the second information item by the use of an information processing device” and that “from the viewpoint of the current information processing technology, it is considered generally impossible to generate information having the predetermined relationship with the first information item in advance of knowing the second information item”.

1) The first information item is a verification key (public key) for verifying electronic signatures, and the second information item is an electronic signature which can be verified by the verification key. 2) The first information item is a hash value, i.e., the calculation result of a hash function, and the second information item is the pre-image of the hash value. 3) The first information item is the product of sufficiently large primes or pseudoprimes P and Q, and the second information is at least one of P and Q. Referring to FIG. 1, the method of providing a service as recited in the above will be explained in detail. First, an electronic signature is made on the first information item received from a user by the information receiving device. This electronic signature is provided by the service provider to certify that the service provider shall provide the service to the user. For example, this electronic signature may be given in exchange for a predetermined amount of real money (the upper section of FIG. 1). The user can confirm his right by verifying this electronic signature.

When receiving the service (the middle section of FIG. 1), the user provides a request for service to the service provider by identifying the first information item. The first information item can be identified directly by providing the first information item, or indirectly by providing any information with which the first information item can be identified. For example, an ID is assigned to the first information item, and the ID is included in the request for service.

If this request is justifiable, the service provider cannot reject it because the first information item is signed. If the request is accepted, the user then provides the second information item. The service provider determines whether or not there is a predetermined relationship between the first information item and the second information item. The second information item having such a relationship cannot be provided by any other than the user. Of course, the service provider cannot calculate the second information. This means that the service provider is not responsible for the leak of information. When the second information item has the predetermined relationship with the first information item, the predetermined service is provided to the user.

In this case, if the second information item identified by the information which is received together with this request has already been received and saved (the lower section of FIG. 1), the request for the service is judged that it is not justifiable. The second information item which has already been received can therefore be used to certify that the service has already been provided, and to reject the request which is not justifiable because the same first information is repeatedly used. Needless to say, if there is a deficiency in the request itself, this request is not accepted.

### Advantageous Effects of Invention

The following advantageous effects can be expected by the method of providing a service in accordance with the present invention.

Risk cost can be Removed. The right to receive a service can and must be safely kept and managed on the service receiving side rather than the service providing side. The service provider therefore need only to provide the service but need not assume the responsibility of managing the information relating to the right and keeping and protecting the right itself.

Trouble can be avoided. Each party takes full responsibility for its action necessary for keep its own benefit, but cannot shift the responsibility on to any other party relating to its own benefit. Any damage is always caused by an act or negligence of the party suffering from the damage. It is always clear where responsibility lies.

### BRIEF DESCRIPTION OF DRAWINGS

FIG. 1 is a view explaining the basic process of the method of providing a service in accordance with the present invention.

FIG. 2 is a view explaining the basic concept of a method of managing electronic money as an example 1 of the present invention.

FIG. 3 is a view explaining the basic concept of the method of managing electronic money according to the example 1.

FIG. 4 is a view explaining the basic concept of the method of managing electronic money according to the example 1, in which the electronic wallet is given a unique serial number.

FIG. 5 is a schematic diagram for showing the method of managing electronic money implemented in the Internet.

FIG. 6 is a block diagram showing the electronic money process server of the example 1.

FIG. 7 is a view showing an example of the electronic wallet structure for use in the method of managing electronic money according to the example 1.

FIG. 8 is a view showing another example of the electronic wallet structure for use in the method of managing electronic money according to the example 1.

FIG. 9 is a block diagram for showing an exemplary structure of the client system through which the user can use the electronic money.

FIG. 10 is a view for explaining the transfer protocol which a proxy signing server follows in response to a transfer request for use in the method of managing electronic money according to the example 1.

FIG. 11 shows the flow of the procedure of purchasing an electronic wallet for use in the method of managing electronic money according to the example 1.

FIG. 12 shows the multiple QR code symbols containing the structure data of an electronic wallet and a private key for use in the method of managing electronic money according to the example 1.

FIG. 13 shows a payment screen for use in the method of managing electronic money according to the example 1.

FIG. 14 shows a purchase/payment screen of a cellular phone for use in the method of managing electronic money according to the example 1.

FIG. 15 shows a payment confirmation screen of a PC for use in the method of managing electronic money according to the example 1.

FIG. 16 is a view showing an example of the process of purchasing an electronic wallet performed in the method of managing electronic money according to the example 1.

FIG. 17 is a view showing the example of the process of purchasing/using an electronic wallet performed in the method of managing electronic money according to the example 1.

FIG. 18 is a view showing another example of the process of purchasing/using an electronic wallet performed in the method of managing electronic money according to the example 1.

FIG. 19 is a view showing a further example of the process of purchasing/using an electronic wallet performed in the method of managing electronic money according to the example 1.

FIG. 20 is a view showing a still further example of the process of purchasing/using an electronic wallet performed in the method of managing electronic money according to the example 1.

FIG. 21 is a view showing a further example of the electronic wallet structure for use in the method of managing electronic money according to the example 1.

FIG. 22 is a view explaining an example of using an electronic wallet only with a cellular phone performed in the method of managing electronic money according to the example 1.

FIG. 23 shows an electronic money receipt for receiving a ticket in accordance with the service providing method of the present invention.

FIG. 24 shows an entrance certificate for entering a concert hall in accordance with the service providing method of the present invention.

FIG. 25 is a view explaining an example of anonymously purchasing tangible goods using electronic money by the method of managing electronic money according to the example 1.

FIG. 26 shows a electronic money receipt for guarantee the right to receive a commodity in accordance with the service providing method of the present invention.

FIG. 27 shows an article receipt certificate for receiving a commodity in accordance with the service providing method of the present invention.

FIG. 28 shows a table for explaining the method of managing electronic money according to the example 1 in which restrictions are imposed on the transfer between electronic wallets.

FIG. 29 shows the electronic wallet structure as an implementation without circulation for use in the method of managing electronic money according to the example 1.

FIG. 30 is a view for explaining the protocol as an implementation without circulation for use in the method of managing electronic money according to the example 1.

FIG. 31 shows the electronic wallet structure including an additional member “message” for use in the method of managing electronic money according to the example 1.

FIG. 32 is a view for explaining the method of managing electronic money according to the example 1 including a plurality of proxy signing servers which can be cooperated.

FIG. 33 is a view showing an example of the electronic wallet structure for use in the method of managing electronic money according to the example 2.

FIG. 34 is a view for explaining the payment example at an online shop in the method of managing electronic money according to the example 2.

FIG. 35 is a schematic diagram for showing a security chip (TPM: Trusted Platform Module) which is customized for use in the broker server for use in the method of managing electronic money according to the example 2.

FIG. 36 is a schematic diagram for showing a MAC unit for use in the broker server for use in the method of managing electronic money according to the example 2.

FIG. 37 is a view showing the structure for managing each electronic wallet on the broker server side in the method of managing electronic money according to the example 2.

FIG. 38 is a view for explaining the withdrawal hash management performed by users in the method of managing electronic money according to the example 2.

FIG. 39 is a view showing the structure for managing each electronic wallet on the user side for use in the method of managing electronic money according to the example 2 in which the withdrawal hash management shown in FIG. 38 is employed.

FIG. 40 is a view showing an example of the electronic wallet structure for use in the method of managing electronic money according to the example 2 in which the deposit hashes are dispensed with.

FIG. 41 is a view showing the structure for managing each electronic wallet on the broker server side in the method of managing electronic money according to the example 2 in which the deposit hashes are dispensed with.

FIG. 42 is a view showing the structure for managing each electronic wallet on the user side in the method of managing electronic money according to the example 2 in which the deposit hashes are dispensed with.

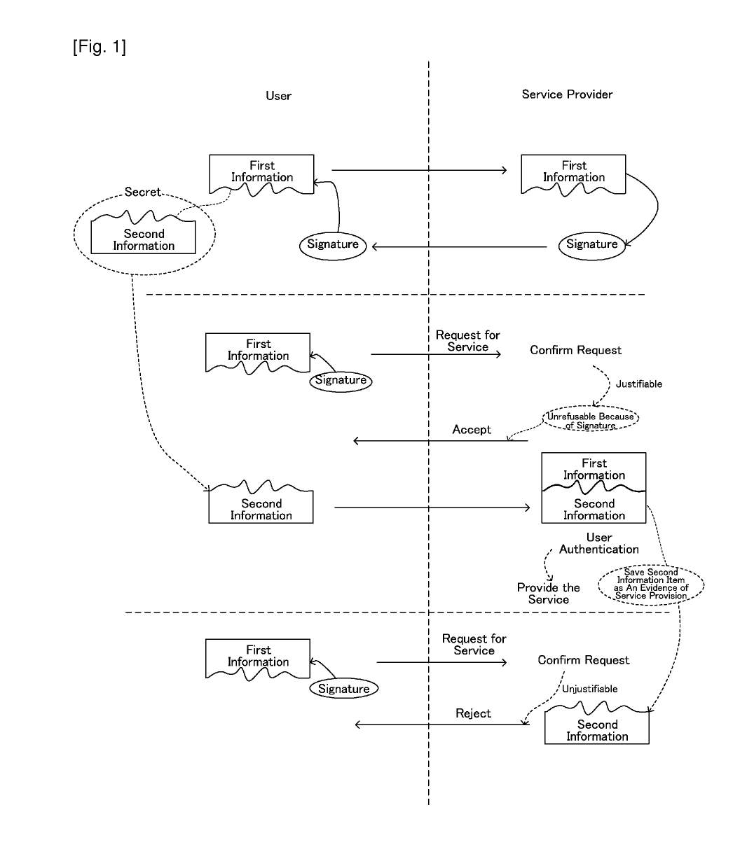

### DESCRIPTION OF EMBODIMENTS

### Example 1

1. Basic Idea

(1) Mechanism

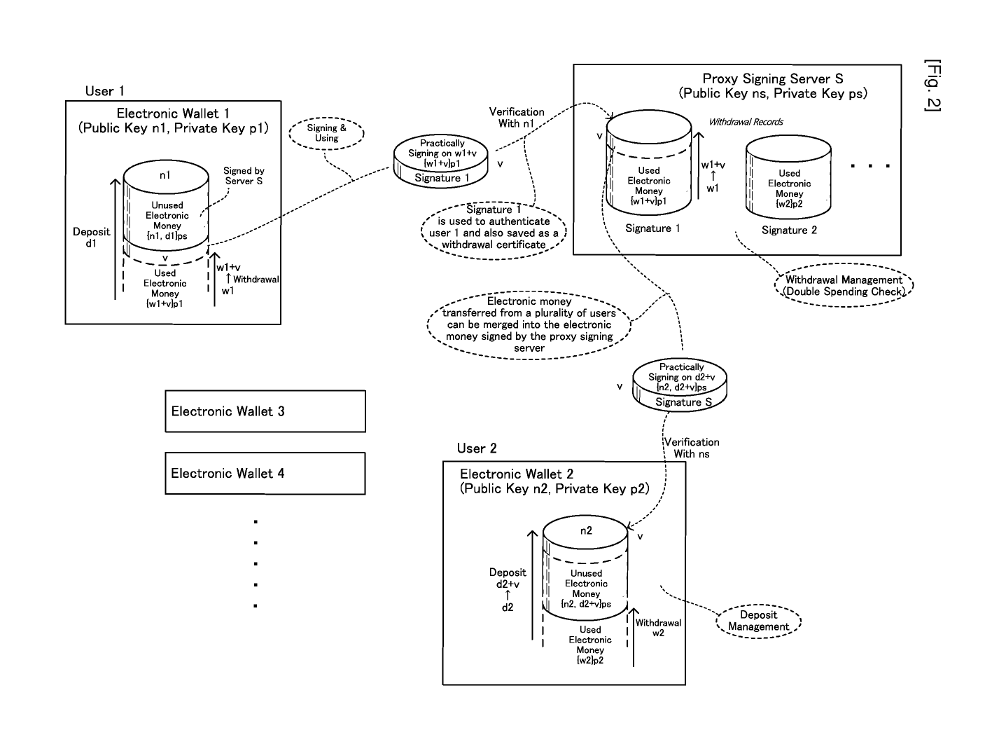

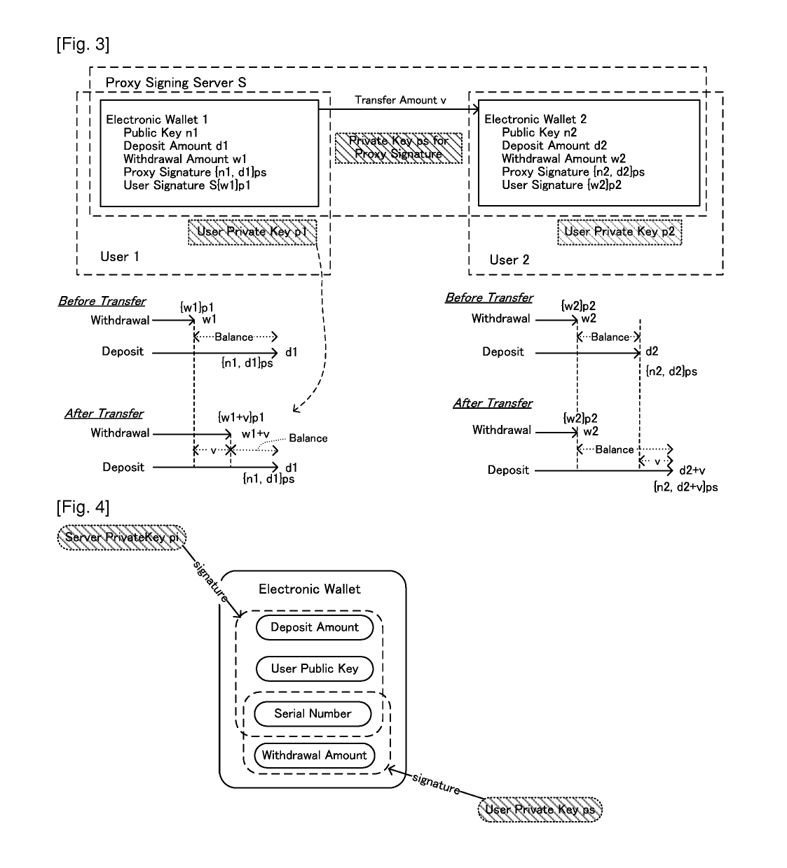

The present example relates to a method of managing electronic money to which is applied the service providing method according to the present invention. FIG. 2 and FIG. 3 are views for explaining the basic concept of this example. Only minimal indispensable elements are included here for the sake of clarity in explanation. While this system can operates as it is, there is some inconvenience in practical use. A preferred implementation will be explained later.

In the case of this example, the users signs electronic money and provide certificates for each other. For example, it is assumed that user 1 having an electronic wallet 1 wants to give user 2 having an electronic wallet 2 a predetermined amount of electronic money. In this case, user 1 transfers the predetermined amount of electronic money from the electronic wallet 1 associated with a public key n1 to the electronic wallet 2 associated with a public key n2. However, if the electronic money signed by user 1 is transferred directly to user 2, many signatures become involved in the electronic wallet 2 so that the process is very complicated.

Thereby, in accordance with this example, a proxy signing server always mediates between the payer and payee in the transfer of electronic money. For mediation, a public key provided by each user is registered as a key element of the electronic wallet of the each user in the proxy signing server. When receiving electronic money together with the signature thereon and a transfer request from user 1, the proxy signing server verifies the signature with the public key n1 of user 1. If the signature is successfully verified, the proxy signing server saves the signature as an evidence, signs electronic money by proxy, and transfers the signed electronic money to user 2. That is to say, the user signature is used to authenticate the user and also saved as a withdrawal certificate. This is an important feature of the present invention.

While the signature of user 1 guarantees the proxy signing server the validity of the electronic money transferred from user 1, the proxy signature directly guarantees user 2 the validity of electronic money. As a result, user 1 consumes electronic money, which is received by user 2 and indirectly but finally guaranteed by the signature of user 1.

Each user of this system cannot deny the validity of proxy signature attached to each withdrawal certificate, because the electronic money of this user is guaranteed by the validity of proxy signature itself. That is to say, if a user denies the proxy signature to deny the use of electronic money, it means that this user denies the electronic money itself which is guaranteed by the same proxy signature itself which this user denied.

In what follows, the process of transferring electronic money will be explained. It is assumed here that user 1 possesses a deposit amount d1 in an electronic wallet 1, and user 2 possesses a deposit amount d2 in an electronic wallet 2. Also, the electronic wallets 1 and 2 are associated with public keys n1 and n2 respectively.

The deposit amount d1 is the accumulated amount of electronic money transferred from other electronic wallets, and signed with the private key ps of the proxy signing server in association with the public key of the electronic wallet 1. The proxy signature {n1, d1}ps is made on the public key n1 and the deposit amount d1 and referred to here as a deposit certificate.

Also, the withdrawal amount w1 is the accumulated amount of electronic money transferred from the electronic wallet 1, i.e., used by the user 1, and signed with the user private key p1 corresponding to the public key n1. The user signature {w1}p1 is referred to here as a withdrawal certificate.

As illustrated in FIG. 3, the above information items are elements of which the electronic wallet is composed, and maintained by the proxy signing server and the user. The balance of the electronic wallet is the deposit amount minus the withdrawal amount.

It is assumed here that user 1 wants to make payment of electronic money v to user 2. User 1 has already spent electronic money up to a withdrawal amount w1 of which the withdrawal certificate has been issued. Accordingly, user 1 sends a transfer request for using the electronic money v as an increment of the withdrawal amount w1 to the proxy signing server. If the withdrawal amount w1+v exceeds the deposit amount d1, the proxy signing server rejects the transfer request. (However, as in one implementation as described below, an exception can be introduced). The proxy signing server then receives a user signature {w1+v}p1 which is made on the withdrawal amount w1+v with the public key n1. It is assumed here that the recipient user (payee) is designated by the public key n2.

The proxy signing server increments the deposit amount d2 of the electronic wallet 2 by v, signs the deposit amount d2 in association with the public key n2 by the use of the private key ps of the proxy signing server. The deposit certificate of the electronic wallet 2 is updated by the result. The balance of the electronic wallet 2 is thereby incremented by v. The withdrawal amount and withdrawal certificate of the electronic wallet 1 are also updated. The process of transferring electronic money is then completed.

The deposit certificate of the electronic wallet 2 is updated in the database of the proxy signing server, and may be downloaded by user 2. Alternatively, as in the following example, the deposit certificate of the updated electronic wallet 2 is returned to user 1 and transferred from user 1 to user 2.

Namely, this means that user 1 has eventually signed a withdrawal v taken out of own electronic wallet 1. On security of this signature, the proxy signing server signs the deposit amount d2 of the user 2 incremented by v. In other words, the proxy signing server makes a proxy signature on the basis of the endorsement made by user 1. For example, if the deposit amount d2 of user 2 contains electronic money transferred from a plurality of users, the deposit certificate can be considered to be signed by the proxy signing server on the deposit certificate on behalf of the plurality of users.

What is important is that user 1 or 2 need not have any support or obtain any certificate for the public key n1 or n2. The user can simply generate a public key in a PC or the like by some utility program and transmit it to the proxy signing server as described below.

As discussed above, the proxy signing server issues a deposit certificate including the public key, and thereby the user cannot deny the public key. The user can objectively certify the validity of the deposit amount only on the basis of the electronic wallet data and the deposit certificate. On the other hand, the proxy signing server can objectively certify the validity of the withdrawal amount only on the basis of the electronic wallet data and the withdrawal certificate.

In the case of the above example, the user public keys are associated with the electronic wallets in a one-to-one correspondence, and serve as an index for identifying the electronic wallets. However, if the user public key is used as an index, there is an inconvenience to search data. In addition to this, it is impossible to generate a plurality of electronic wallets with the same user public key. In practice, as illustrated in FIG. 4, a unique serial number may be assigned to an electronic wallet, and the deposit certificate and withdrawal certificate certify also this serial number together with electronic wallet information.

(2) Electronic Money Issuance

The above proxy signing server serves to simply circulate electronic money from one user to another in the same manner as circulating cash. Next is the description of how to issue electronic money and give value to electronic money.

No electronic money exists before issuance. One method of issuing electronic money is to generate a usual electronic wallet for the issuer and initialize the deposit amount to a sufficient amount of electronic money issued when the system is built in the proxy signing server. This is electronic money issuance.

After the issuance, the electronic money can circulate in the Internet by transferring electronic money from the first electronic wallet to others, and then between any electronic wallets. The user who wants to use electronic money can exchange yen for electronic money in the same manner as yen for dollar.

The creditworthiness of electronic money is secured for example by making a deposit in correspondence with the issued amount of electronic money by the issuer (or the transfer amount from the electronic wallet of the issuer), and publicize a certificate of the issuer which certifies, in connection with the public key ps of the proxy signing server, that the electronic money can be exchanged for yen, dollar or the like, that the electronic money can be used at shops in a shopping mall, or that the electronic money can be used for particular purposes. The signature of the issuer attached to this certificate is certified by a public key certificate issued by a certificate authority (CA).

Meanwhile, in this case, the serial number of the electronic wallet of the issuer is 0, but the serial numbers of other electronic wallets have not been given yet. As described below, when receiving a transfer request with a public key without designating a serial number, the proxy signing server transfers electronic money to an electronic wallet which is given a new serial number and associated with this public key. For example, the buyer of a new electronic wallet pays real money and transfers a public key to the owner of an electronic wallet (hereinafter referred to as the payer electronic wallet which may be the first electronic wallet of the issuer), from which electronic money is transferred to the new electronic wallet.

(3) Electronic Money Issuance

In the above example, the electronic wallet of the issuer is handled in the same manner as other electronic wallets, such that the operation of the proxy signing server is simple Alternatively, the electronic money can be issued by giving the electronic wallet of the issuer (i.e., the serial number is 0) special treatment such that the withdrawal amount can be greater than the deposit amount. In this case, the initial deposit amount need not be input, and the deposit amount and the withdrawal amount are 0 respectively. The withdrawal amount is the accumulated amount of issued electronic money, and the deposit amount is the accumulated amount of electronic money which is transferred from other electronic wallets, for example, for encashment. The current electronic money supply is the withdrawal amount minus the deposit amount.

A plurality of banks may be independent issuers. In this case, the settlement among the banks can be made by transferring electronic money among the electronic wallets of the banks. For example, the electronic wallet of an issuer has a serial number of 0x000000** where “*” can be any hexadecimal number. The proxy signing server accepts an electronic money transfer request from an electronic wallet of such a serial number even if the withdrawal amount exceeds the deposit amount.

2. Implementation Example

In what follows, as a specific example on the basis of the above basic concept, an implementation of the method of managing electronic money will be explained. Any digital signature algorithm using public-key cryptography can be used in the following example. Namely, a signature is generated by processing plaintext with a signing key, and the signature is verified by processing the plaintext with a verification key. However, in a database, only the information unique to each record is important. Thereby, in this description, only the verification key information which is unique to each specific key pair is often referred to as a public key, and only the secret signing key information of the specific key pair is often referred to as a private key. For example, in the RSA signature scheme, the plaintext c and the signature s are associated as follows.

c=ŝe mod n

s=ĉd mod n

Namely, the signature s can be calculated from the plaintext c with d and n. Conversely, the plaintext c can be calculated from the signature s with e and n. That is, the signing key is d and n, and the verification key is e and n. Usually, e is a predetermined common constant so that n is substantially the verification key which is a public key unique to each record (electronic wallet). On the other hand, since the verification key is public, d is substantially the signing key (private key) to be kept a secret.

Accordingly, in the following description, only d is referred to as a private key, and only n is referred to as a public key. Also, in the following description, the process of signing plaintext is often referred to as the process including the preprocess such as padding and hashing the plaintext. For example, if a signature is generated by performing modular exponentiation of text data with a private key as exponent, this process is referred to as signing the text data with the private key. On the other hand, if a signature is generated by hashing and/or padding text data and performing modular exponentiation of the text data with a private key as exponent, this process is referred to also simply as signing the text data with the private key. Furthermore, in the following implementation example, the plaintext which is in a predefined format is handled separately from the signature which is an electronic signature certifying the plaintext. Since the plaintext to be certified can be generated from other available information in the case of this system, the electronic certificate can be constructed by combining the signature and the generated plaintext. Thereby, in the following implementation example, the signature is often referred to alone as a certificate.

There are several examples of the electronic wallet structure representing the data of an electronic wallet in the following description. These examples are based on the RSA signature algorithm which is most popular as an electronic signature algorithm. However, a similar electronic wallet structure can be easily defined with any other signature algorithm such as ECDSA which is characterized in that the key lengths are very short.

(1) System Configuration

(Electronic Money Process Server)

As shown in FIG. 5, an electronic money process server 1 is connected to the Internet. The user of the electronic money owns an electronic wallet to be described below, and uses a service by accessing the server 1 from a personal computer (PC), PDA, cellular phone or the like through the Internet.

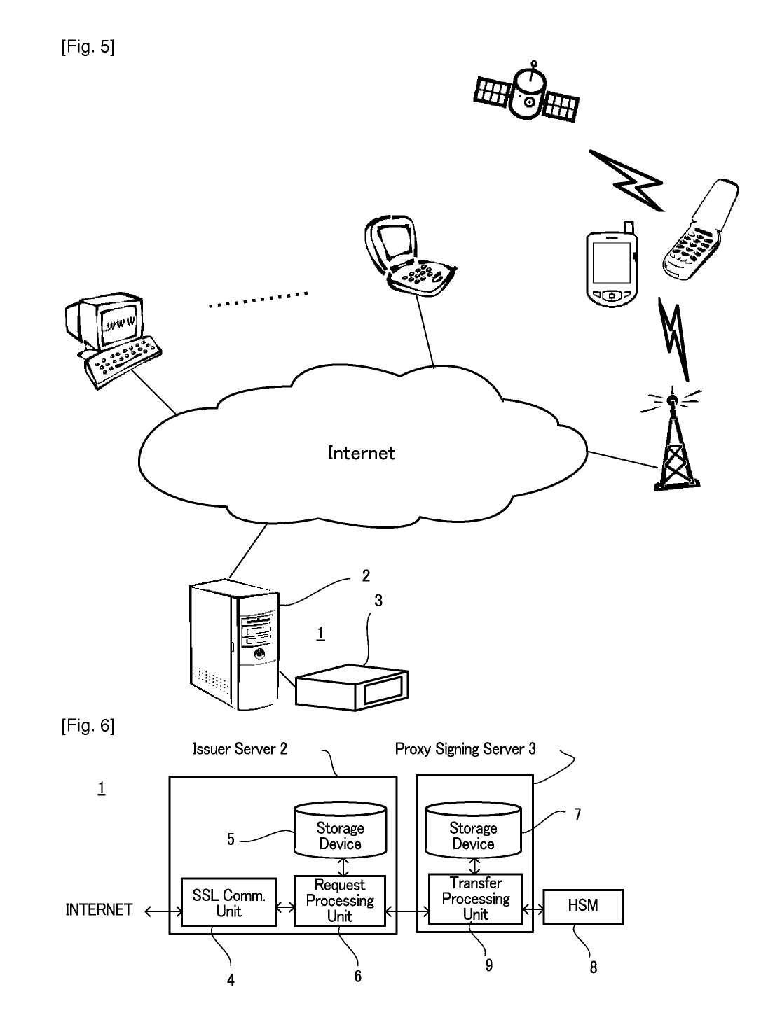

Also, as shown in FIG. 6, the electronic money process server 1 includes an issuer server 2 and a proxy signing server 3. The issuer server 2 and the proxy signing server 3 are implemented with general purpose computers respectively, and connected with each other by a communication cable such as 1000BASE-T, USB3, IEEE1394 or the like. The security can be improved by designing the proxy signing server 3 as a dedicated computer.

The issuer server 2 includes an SSL communication unit 4 for receiving a transfer request through the Internet, a storage device 5, and a request processing unit 6 for processing the transfer request received through the SSL communication unit 4 with the storage device 5. In this case, the SSL communication unit 4 performs communication secured by SSL which includes TLS (Transport Layer Security).

The proxy signing server 3 includes a storage device 7 for storing electronic wallet structure data, an HSM (hardware security module) 8 for storing a private key used to make proxy signatures and performing cryptographic processing, and a transfer processing unit 9 for transferring electronic money from one electronic wallet to another managed in the storage device 7.

In this example, the proxy signing server 3 makes use of the SSL communication unit 4 of the issuer server 2 for performing communication through the Internet. Accordingly, since the proxy signing server does not directly perform communication through the Internet, the combination of the electronic money process server 1 and the proxy signing server 3 serves fully as a proxy signing server which includes the client system of the issuer. This is because the issuer which is a client of the proxy signing server is also the operator of the proxy signing server, partly for the purpose of security. Of course, the proxy signing server 3 may be connected to the issuer server 2 through the Internet.

The transfer processing unit 9 is implemented only with functionality of transferring electronic money. That is, the functionality is to reject a transfer request if it is not justifiable, and to accept a transfer request if it is justifiable and transfer electronic money between electronic wallets stored in the storage device 7 according to a protocol to be described below. Other necessary functions are implemented within the issuer server 2. By this configuration, the security can be improved with respect to transferring electronic money.

In this case, the issuer server intercepts each transfer request and then transfers the each transfer request to the proxy signing server 3. Conversely, the issuer server intercepts the response from the proxy signing server 3, and then transfers the response to the user. By this configuration, if necessary, it is possible to manage user information corresponding to each electronic wallet, save backup data relating to electronic wallets, and so forth.

The HSM 8 can generate signatures with the private key for proxy signature in response to the request from the transfer processing unit 9 at a high speed without outputting the private key. Furthermore, the HSM 8 may perform verification of signatures from users.

In this case, the security is improved by using separate computers as the issuer server 2 and the proxy signing server 3 respectively. However, in a simple design, the issuer server 2 and the proxy signing server 3 can be implemented within a single workstation.

(Electronic Wallet Structure)

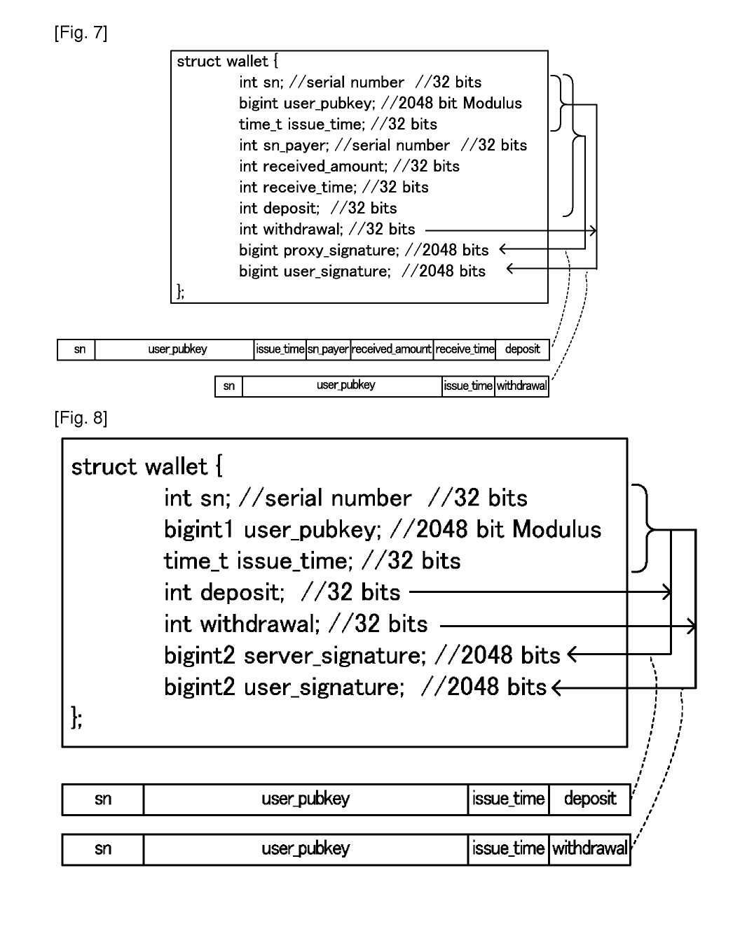

Electronic money is stored in an electronic wallet. One electronic wallet corresponds to one instance of the electronic wallet structure. This electronic wallet structure has a structure as shown in FIG. 7. Instances of the electronic wallet structure are saved both the proxy signing server and partly by the user of each electronic wallet. However, only each user can safely manage the electronic money stored in the electronic wallet, and therefore each user is basically responsible for safely managing the electronic money stored in the electronic wallet as described below in detail. On the other hand, the proxy signing server has to check double spending of the same electronic money.

The electronic wallet structure consists of ten members, i.e., “sn” (32-bit integer) which is the serial number as the identification number of this electronic wallet, “user_pubkey” (2048-bit integer) which is the public key of the user, “issue_time” (32-bit integer) which is the issue date and time, i.e., the date and time when the electronic wallet is issued, “sn_payer” (32-bit integer) which is the serial number of the payer as the serial number of another electronic wallet from which this electronic wallet last received electronic money, “received_amount” (32-bit integer) which is the amount of the last received electronic money, “receive_time” (32-bit integer) which is the date and time when the electronic money is last received by this electronic wallet, “deposit” (32-bit integer) which is the deposited amount, “withdraw” (32-bit integer) which is the withdrawn amount, “proxy_signature” (2048-bit integer) which is a proxy signature generated by the proxy signing server, and “user_signature (2048-bit integer) which is a user signature generated by the user. In FIG. 7, 2048-bit integer type is indicated as “bigint”, which will be processed as an array of primitive type integer by programs.

In this case, the payer serial number “sn_payer”, the received amount “received_amount”, the receipt time “receive_time” are introduced to certify the fact of electronic money transfer as will be described below. However, these members can be dispensed with depending upon the application. When these members are dispensed with, the structure for managing electronic wallet is more compact as illustrated in FIG. 8.

Anyway, there is no pointer member in this structure, and an electronic wallet consists only of fixed length data elements. Accordingly, the database may consist only of 796-byte fixed length records which are stored with constant intervals.

In practice, the proxy signature field is not used in the proxy signing server, and thereby it can be dispensed with. When this field becomes necessary, it can be calculated from the values of other fields. In this case, the size of one electronic wallet record of the database is 540 bytes.

Usually, the serial number is used as the primary key. However, if the address of the electronic wallet record corresponds to the serial number, it can directly be accessed by the address calculated from the serial number, so that 536-byte data can be stored as an electronic wallet instance by omitting the serial number field. For example, each record can be accessed by base address+sn*536. The letter “*” is often used as a multiplication operator in this description.

Also, the user keeps the data of an electronic wallet he possesses, together with the private key corresponding to the user public key thereof. However, the user signature may be dispensed with because it is not used on the user side. If necessary, the user signature can be calculated from the values of other fields. When the user signature is dispensed with, the size of the data of the electronic wallet to be saved is 540 bytes.

As described below, the first instance is the electronic wallet of the issuer and given a serial number “0”. The electronic wallet structure instance of the serial number S can be accessed by address D*S where D is the size of the electronic wallet structure if the base address is 0. For example, the instance of the serial number S can be accessed by address 540*S.

One electronic wallet corresponds to one structure instance, which is stored in the database in the form of binary data as it is. Also, one electronic wallet is transmitted as binary data and stored as a binary data file on the user side. Incidentally, the electronic wallet is given the serial number sn in a one-to-one correspondence, and the electronic wallet having the serial number sn is often referred to herein as the electronic wallet sn in the following explanation.

(Configuration of Client System)

FIG. 9 is a view for showing an exemplary structure of the client system through which the user can use the electronic money.

Namely, this system includes an SSL communication unit 11 for performing SSL communication, a signature unit 12 for generating signatures, a verification unit 13 for verifying signatures, an encryption key generation unit 14 for generating encryption keys, a private key storing unit 15 for storing user private keys, and an electronic wallet structure storing unit 16 for storing electronic wallet data. Furthermore, there is a processing control unit 17 for controlling the overall process.

Each of these units shown in the drawing may be implemented as a software module or a hardware (firmware) module depending upon the implementation of the system. Also, each unit may be implemented as an individual module, or combined with other unit(s) as a multifunctional module. Furthermore, the private key storing unit 15 and the electronic wallet structure storing unit 16 may be implemented as the same storage device, and may be used to store the private keys and electronic wallet structures in the form of encrypted data.

Next is the description of an personal computer (PC) which is used as the client system. Needless to say, an OS is installed in the PC to provide system services such that the Internet can be accessed from a program.

A plug-in module of a Web browser is most commonly thought as an electronic wallet program to implement the above units. In this case, this plug-in has access privilege to the electronic wallet data in the PC, e.g., by an electronic signature. This plug-in may generate public/private key pairs, provides signatures, verifies signatures, updates electronic wallet data in response to user's operation or in accordance with an HTML file. More specific operation and process will be explained later in accordance with the purpose of handling electronic wallets.

The electronic wallet data and the user private key may be stored, for example, in an external USB memory or a hard disk of the PC after encryption. In this case, the encryption key is not saved but generated from a password when needed. However, it is not recommended to handle the electronic wallet data and user private key in the same PC. An HSM may be used, while costly, such that the private key is used only in this HSM. Several examples of handling the electronic wallet data and user private key separately without resorting to such an expensive HSM will be later explained.

(Electronic Certificate)

The member “proxy_signature” is the electronic signature which is generated by the proxy signing server with the private key of the proxy signing server for signing the bit sequence as plaintext formed by simply concatenating the members “sn”, “user_pubkey”, “issue_time”, “sn_payer”, “received_amount”, “receive_time”, and “deposit” of the aforementioned electronic wallet structure together.

On the other hand, the member “user_signature” is the electronic signature which is generated by the user with the private key corresponding to the user public key “user_pubkey” for signing the bit sequence as plaintext formed by simply concatenating the members “sn”, “user_pubkey”, “issue_time”, and “withdraw” together. The signature algorithm to be used is designated, for example as SHA256WithRSAEncryption, in the standard conditions (agreement as described below) which is provided and publicized by the issuer of this electronic money. Different algorithms may be designated between the proxy signature and the user signature. The user can use electronic money stored in an electronic wallet, which is an instance of the electronic wallet structure, by using the user private key corresponding to the user public key thereof.

The public key used for verifying proxy signatures can be separately downloaded, and verified by the public key certificate issued by a CA as the public key of the system provider. On the other hand, the user public key is certified by the proxy signature. As a consequence, the proxy signature is a deposit certificate in combination with the serial number “sn”, the user public key “public key”, the issue date “issue_time” and the deposit amount “deposit”. Likewise, the user signature is a withdrawal certificate in combination with the serial number “sn” and the withdrawal amount “withdraw”.

The balance of the electronic wallet is the deposit amount minus the withdrawal amount. The deposit amount is the cumulative total of amounts deposited as from the issue date of the electronic wallet. Likewise, the withdrawal amount is the cumulative total of amounts withdrawn as from the issue date of the electronic wallet. Accordingly, the user can use electronic money up to the balance. That is to say, the proxy signing server can reject the use of electronic money exceeding this balance.

On the other hand, as public information, an agreement relating to the use of electronic money is provided such that it can be downloaded from the site of the electronic money issuer. One party involved in this agreement is the issuer, and the other is each user who possesses the private key corresponding to the public key which is certified by the deposit certificate of an electronic wallet.

The agreement is accompanied by the signature of the issuer certified by a CA, and includes at least the following information.

1) The specification and expiration date of electronic wallet structure, and the protocol with which the proxy signing server follows.

Namely, the operation of the proxy signing server is described here. There is also the description about the scheme of the proxy and user signatures and the public key for use in verifying proxy signatures. For example, it is designated to use the RSA signature scheme with 2048-bit keys and a public exponent of 65537 and the hash function SHA-256 and so forth. Also, the expiration date is determined, for example, as one year from the issue date of electronic wallet. A preferred example of the communication protocol followed by the proxy signing server will be explained later in detail.

2) The information of the issuer, and the usage scope of the electronic money.

Namely, there is a description of who is the issuer and how the user can use the electronic money.

3) The scope of responsibilities of the issuer and the users.

Namely, it is confirmed here that the issuer need not take any responsibility for a transaction performed on the basis of a correct withdrawal certificate. This means that any one possessing a correct withdrawal certificate which has not disclosed yet to the proxy signing server has a right to use electronic money corresponding to the withdrawal certificate. Also, it is confirmed that when receiving a request for using electronic money, the proxy signing server cannot refuse the use request unless showing the withdrawal certificate corresponding thereto.

(2) Operation of Proxy Signing Server

Next is the description of the protocol which the proxy signing server follows in response to a request from the user. The request is for transferring electronic money from one electronic wallet to another.

(Electronic Wallet of The Issuer Itself)

As described above, when transferring electronic money, the payer electronic wallet has a certain balance no lower than the amount of electronic money to be transferred. Accordingly, unless the electronic wallet of the issuer has been set up as the initial settings of the proxy signing server, the electronic money system is unable to go on.

In this case, the electronic wallet of the issuer has 0 as the serial number and the public key of the issuer as the user public key. The public key of the issuer may be different than the public key of the proxy signing server for verifying the deposit certificate. According to the scheme of this example, the issuer is only one of the users of the proxy signing server. The issue date is set to a far future date such as three hundred years from the actual issue date for reasons of expediency. This setting prevents this electronic wallet from being expired. The deposit amount is set to “0x40000000”, and the withdrawal amount is set to “0”. In this case, while the balance as seen from the proxy signing server is 0x40000000, the effective balance is considered to be 0 from the view point of accounting. The effective balance may be calculated as (deposit amount−0x40000000)−withdrawal amount, which is usually minus. Other initial settings have no effect on the operation of the server and electronic money, and thereby these values are set to NULL.

As described below, when a user purchases a new electronic wallet, electronic money is transferred to the electronic wallet of the issuer to the new electronic wallet. Accordingly, a sufficient deposit amount is assigned to the electronic wallet of the issuer as an initial value. The number of bits for the deposit amount may be increased depending upon the application.

Conversely, if the user requests that the issuer encashes electronic money of the user, the electronic money is transferred to the electronic wallet of the issuer from the electronic wallet of the user. Just after starting the electronic money system, only the electronic wallet of the issuer has a balance from which electronic money is transferred to other electronic wallets, followed by transferring electronic money among the electronic wallets of consumer users. The total balance as seen from the system does not vary. However, in this example, there is a predetermined charge for transferring electronic money such that the increment of the withdrawal amount of the payer electronic wallet is equal to the increment of the deposit amount of the payee electronic wallet plus the predetermined charge. The total balance as seen from the system decreases each time electronic money is transferred between electronic wallets.

In the following example, the proxy signing server only mechanically transfers electronic money from one electronic wallet to another. Accordingly, as seen from the proxy signing server, the issuer is only a user with no difference than other users. However, in another scheme as described above, the electronic wallet of the issuer is handled in an exceptional manner.

(Transfer Protocol)

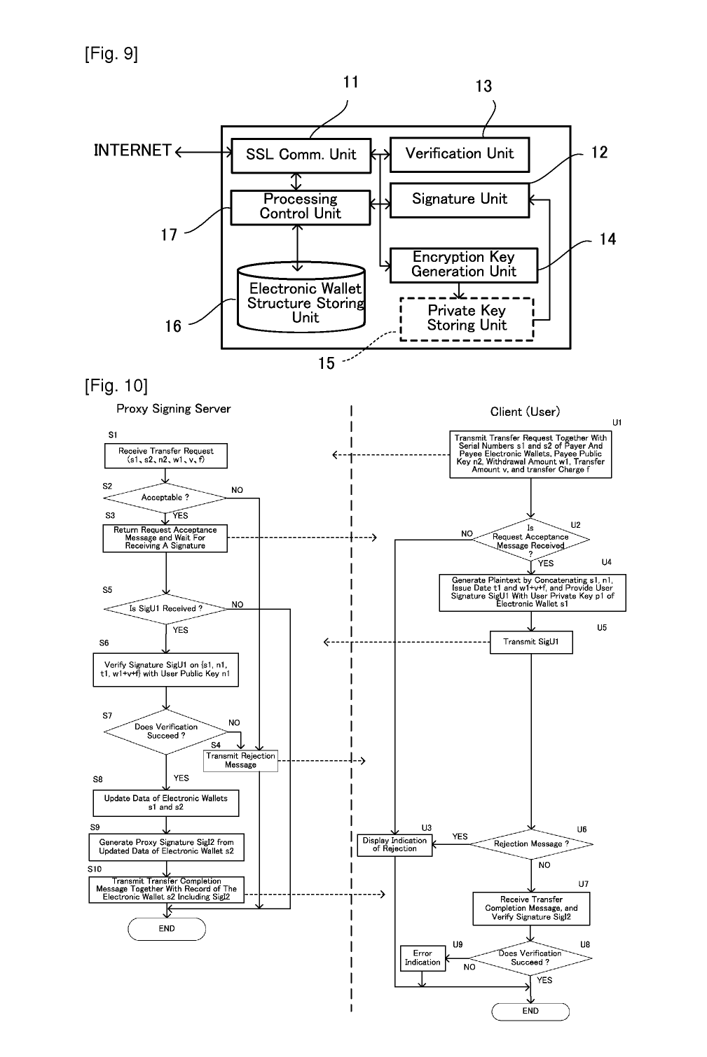

In what follows, the transfer protocol which the proxy signing server follows in response to a transfer request will be explained with reference to FIG. 10. The process following this transfer protocol is completed within one SSL session. In this case, only server authentication is performed, but client authentication is not performed by SSL. If the process is interrupted due to the timeout set to the session, the process information of the session is discarded. The timeout occurs corresponding to the maximum time the session can be maintained.

It is assumed that the user pays charge “f” for electronic money transfer. However, the proxy signing server may be designed such that electronic money transfer incurs no charge if the payer electronic wallet is of the issuer. First, the user who wishes to transfer electronic money sends a transfer request (U1) through a client terminal together with the serial numbers s1 and s2 of payer and payee electronic wallets, the user public key n2 of the payee electronic wallet, a withdrawal amount w1, a transfer amount v, and a transfer charge f. Alternatively, in the above system example, the issuer server 2 intervening between the proxy signing server and the user may require the payer user to attach the user public key n1 of the payer electronic wallet for the purpose of improving security. In this case, if the user public key n1 is not correct, the transfer request is not transmitted to the proxy signing server, but rejected.

The user public key n2 of the payee electronic wallet can be omitted. Namely, the user public key n2 attached to the transfer request may be NULL. The proxy signing server accepts this NULL key as a correct payee public key. If the payer user knows the correct user public key n2, erroneous transfer due to a wrong serial number can be avoided. For example, if an online shop as the payee makes available a public key certificate in addition to the serial number of the payee electronic wallet, the user (customer) can certainly identify the payee by sending the transfer request with the public key of the certificate.

When 0xFFFFFFFF is assigned to the serial number s2 of the payee electronic wallet, it is indicated that electronic money is to be transferred to a new electronic wallet. In this case, the proxy signing server processes the structure instance of the new electronic wallet by determining an unused serial number. The transfer request has to include a public key to be the user public key n2 of the new electronic wallet.

The proxy signing server receives this transfer request (S1), and determines whether or not this transfer request can be accepted. If accepted, the proxy signing server holds an exclusive lock on the records (structure instances) of the electronic wallets s1 and s2 in the database of the proxy signing server in order to prevent another transaction from accessing the data, transmits a transfer request acceptance message to the client terminal (S3), and waits for receiving a signature from the client terminal as a withdrawal certificate.

Conversely, if the transfer request cannot be accepted, the proxy signing server returns a rejection message (S4). For example, the transfer request is rejected if the received withdrawal amount w1 is inconsistent with the record of the database of the proxy signing server, if the sum of the received withdrawal amount w1, the transfer amount v and the charge f exceeds the deposit amount of the electronic wallet s1, and so forth. However, in the case where the electronic wallet of the issuer is handled in an exceptional manner in another scheme as described above, the transfer request issued from the issuer is not rejected even if the sum of the received withdrawal amount w1, the transfer amount v and the charge f exceeds the deposit amount of the electronic wallet s1. Also, the transfer request is rejected if the received user public key of the payee electronic wallet (other than 0xFFFFFFFF) is inconsistent with the record of the database of the proxy signing server.

The rejection message is sent to the client terminal together with the reason. If the received withdrawal amount w1 is smaller than that recorded in the database of the proxy signing server, the user signature of the electronic wallet structure is transmitted to as evidence to the client terminal together with the recorded withdrawal amount w1. The user can confirm by the received withdrawal amount and user signature that the electronic money corresponding thereto has already been consumed.

Needless to say, only one transfer request is accepted for one electronic wallet. Namely, the transfer request is rejected if the corresponding record is exclusive locked while the electronic wallet s1 or s2 is processed. If not accepted (U2, NO), an indication is displayed in the client terminal (U3).

After receiving the transfer request acceptance message (U2, YES), the client terminal generates 2144-bit plaintext which consists of s1 (32-bit integer), the user public key n1 (2048-bit integer), the issue date t1 (32-bit integer) and w1+v+f (32-bit integer), which are concatenated together. The client terminal then generates a user signature {s1, n1, t1, w1+v+f}p1 by signing the plaintext as SigU1 (U4). Incidentally, this concatenation is to simply link data together in the form of a bit sequence as described above. This user signature SigU1 is transmitted to the proxy signing server (U5).

If the signature SigU1 is not received within a predetermined period (S5, NO), the proxy signing server terminates the process. If the signature SigU1 is received (S5, YES), the proxy signing server verifies the received signature SigU1 on the plaintext {s1, n1, t1, w1+v+f} by the use of n1 (S6). If verification fails (S7, NO), a rejection message is send to the client terminal together with the reason followed by terminating the process. This means that the signature SigU1 is used to perform client authentication. Receiving the rejection message (U6, YES), the client terminal displays an indication of the rejection followed by terminating the process.

If verification succeeds (S7, YES), the data of the electronic wallets s1 and s2 is updated (S8). Namely, the withdrawal amount w1 and user signature of the electronic wallet s1 are updated to w1+v+f and SigU1 respectively. On the other hand, in the structure instance of the electronic wallet s2, the payer serial number, received amount and receipt time are updated to s1, v and the current time tc respectively. Furthermore, the deposit amount d2 is updated by adding v thereto. In the case where the electronic wallet s2 is a new electronic wallet, the received public key, the current time tc, 0 and v are assigned to the user public key n2, issue date t2, withdrawal amount w2 and deposit amount d2 of the payee electronic wallet s2 respectively.

Next, on the basis of the updated data, the proxy signing server generates 2240-bit plaintext which consists of the serial number s2, the user public key n2, the issue date t2, the serial number s1 of the payer electronic wallet, the transfer amount v, the receipt time tc and the deposit amount d2, and generates a proxy signature SigI2 (={s2, n2, t2, s1, v, tc, d2}ps) by signing the plaintext.

Finally, the proxy signing server completes the electronic money transfer process by transmitting a transfer completion message to the client terminal together with the record of the electronic wallet s2 including the signature SigI2 (S 10). In this case, the proxy signature can be verified on the client side even without the withdrawal amount w2 and the user signature SigU2. It is therefore possible to omit the withdrawal amount w2 and/or the user signature SigU2 from the transfer completion message.

After receiving the transfer completion message, the client terminal verifies the signature SigI2 of the electronic wallet s2 (U7), and terminates the process if the verification succeeds (U8, YES). If the verification fails (U8, NO), although not probable, an error message is displayed (U9).

The client terminal performing the transfer of electronic money receives the deposit certificate including the signature SigI2 together with the transfer completion message. This deposit certificate is effective also as a transfer certificate which certifies that the electronic money of the received amount v (received_amount) is transferred from the electronic wallet s1 (sn) to the electronic wallet s2 (sn_payer) in the receipt time (receive_time). The client terminal can transmit the received deposit certificate to the payee (e.g., shop) for confirmation of payment. Also, if the payee makes available a public key certificate issued by a CA, the transfer certificate serves to identify the owner of the payee electronic wallet.

In the above protocol, the payer does not always have to transmit the user public key of the payer electronic wallet. However, the security can be improved by always requiring the transmission of the user public key of the payer electronic wallet. In this case, the transfer request is rejected unless the correct user public key of the payer electronic wallet is transmitted.

Also, the private key for making a proxy signature during electronic money transfer need not be identical to the private key which has been used for making the proxy signature of the payee electronic wallet as long as the new public key certificate is made available. Namely, the key can be updated at any time. While the expiration date of the public key certificate is longer than the previous date, the expiration date of the corresponding electronic wallet may preferably be extended.

(3) Using Electronic Money

The electronic money of this example is used by transferring electronic money from one electronic wallet to another. For example, a buyer of commodity makes payment by transferring electronic money from his electronic wallet to the electronic wallet of the online shop. In this case, the electronic wallet of the online shop is always the payee electronic wallet, and thereby during transaction the online shop has only to verify the received transfer certificate for confirming the payment. Accordingly, the private key of the online shop is used, e.g., only for monthly settlement redeeming the electronic money so that it is easy to manage the private key.

The electronic money (electronic wallet) can be purchased in the same manner as purchasing online content. Namely, the buyer can purchase an electronic wallet by designating a combination of a user public key and a deposit amount as a commodity. An online shop (the issuer itself of the electronic money, or other broker) receives the payment, and transfers the deposit amount of electronic money from its electronic wallet to a new electronic wallet associated with the designated public key. The transfer certificate is given to the buyer. The buyer can confirm the electronic wallet with reference to the transfer certificate.

Encashment is also possible. Namely, the user transfers electronic money corresponding to an amount of encashment and the charge designated by the online shop from his electronic wallet to an electronic wallet designated by the online shop. The online shop confirms the transfer certificate and performs encashment, e.g., through a bank account of the user.

Next is the description of the specific steps in which a consumer uses the electronic money according to this example. In the case where the transaction is limited to small payments, a more simpler and user-friendly procedure can be employed than as described below. However, a procedure having enhanced security will be explained here.

(Purchase of Electronic Wallet 1)

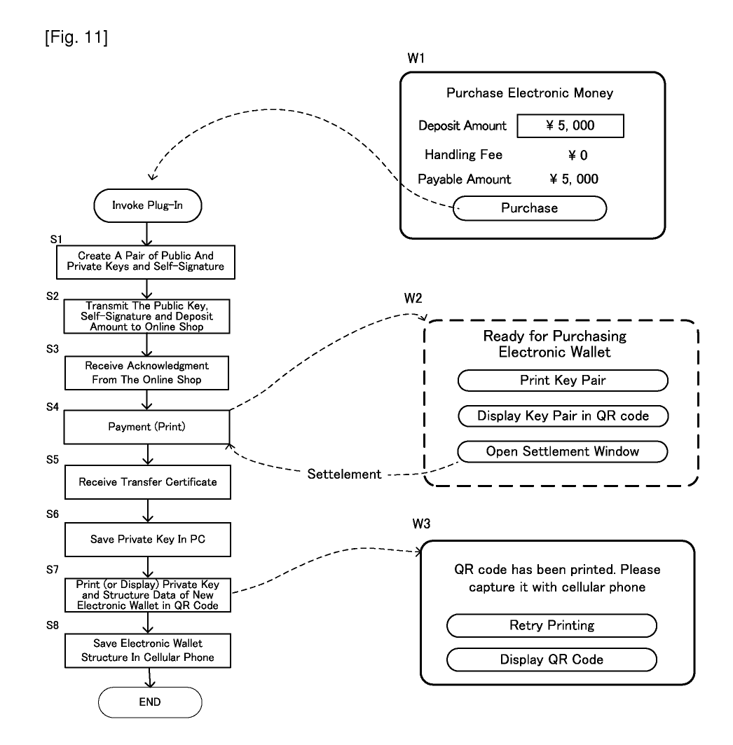

An electronic wallet can be purchased from an online shop in the same manner as paid content as has been discussed above. It is assumed however that a plug-in is installed in a browser as an electronic wallet utility, and that this plug-in is given access privilege to a local storage device (e.g., HDD) in the PC, e.g., by an electronic signature. Also, it is assumed that the buyer possesses a cellular phone in which is installed an application for handling electronic wallets. This cellular phone is provided with a built-in camera. In what follows, the procedure of purchasing an electronic wallet will be explained with reference to FIG. 11.

Namely, when the buyer accesses an SSL site of the shop and selects an electronic wallet as a commodity in the online shop's site, a window W1 is opened. The buyer designates a deposit amount in the window, and presses a purchase button to invoke the plug-in. The process performed by the plug-in is as follows.

First, after displaying that the process is in progress, a pair of public and private keys is created. A self-signature is then calculated by signing the public key (user public key) with the private key of the key pair (S1). The key pair is saved only in a memory but not stored in a disk. Then, the plug-in transmits the user public key, the self-signature and the deposit amount to the online shop (S2). The online shop verifies the received self-signature, and returns acknowledgment to the plug-in (S3). When receiving the acknowledgment, the plug-in quits displaying that the process is in progress, and opens a window W2 to display an indication that it is ready for purchasing an electronic wallet (S4).

In this indication, the public and private keys can be printed in the form of QR code or the like. Alternatively, the QR code can be displayed in the screen and captured by the built-in camera of the cellular phone. This process is provided only for communication error or the like, so that the window W2 can be omitted to simplify the process. Then, the screen for payment is displayed, and payment is made in the same manner as when purchasing usual commodity such as online content. The above payment procedure can be performed in the same manner as usual online payment procedure, which is well known and will not be described here.

After confirming payment, the online shop transfers electronic money to the new electronic wallet corresponding to the received public key. The transfer certificate is then downloaded to this PC through the plug-in (S5). A file for storing this transfer certificate is created in the PC as a temporary file which cannot be shared with any other process. The plug-in then saves the private key of the new electronic wallet in a predetermined storage area of the PC in association with a reference number as an identifier (S6).

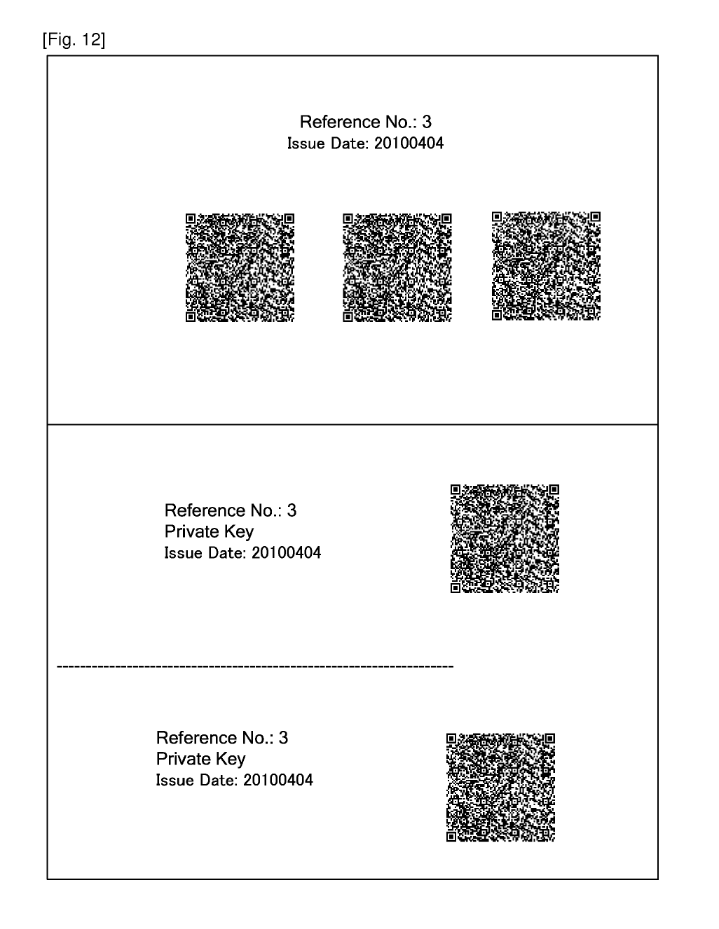

Also, the plug-in generates QR code containing the structure data of this new electronic wallet and QR code containing the private key from the transfer certificate, and prints the symbols of QR code (S7) as shown in FIG. 12 in which the structure data is printed in the upper area, and the private key is redundantly printed in both the middle and lower areas. The QR code of the structure data consists of multiple symbols, but contains no data of the user signature whose initial value is always 0. The temporary file is completely deleted after printing, and thereby no information about the electronic wallet remains in PC except for the private key. The QR code of the structure data (as printed in the upper area) is captured by the cellular phone through the above application, and the electronic wallet structure is managed by the above application (S8).

As has been discussed above, the electronic wallet structure and the private key are separately saved by the cellular phone and the PC. Accordingly, the electronic wallet can be used only when both the cellular phone and the PC are available such that the security becomes high. However, even when leaving home, the electronic wallet can be used only with the cellular phone by separating and carrying the lower area with the printed QR code of the private key as described below. For example, the paper slip of the private key may be kept in a real wallet.

Of course, although there is a certain risk, the QR code of the private key can be captured with the camera and managed by the cellular phone. Anyway, the printed paper slip serves as a backup means so that there is no fear of losing.

(Using Electronic Wallet)

The user can use the electronic wallet with a cellular phone side. The cellular phone includes the application installed for handling electronic wallet, and an electronic wallet structure as described above.

It is also assumed that a plug-in is installed in a browser as an electronic wallet utility as described above, and that this plug-in is given access privilege to the electronic wallet data in the PC, e.g., by an electronic signature. Many of currently available cellular phones are capable of performing SSL communication and handling APIs of PKI, and thereby can be used for this purpose.

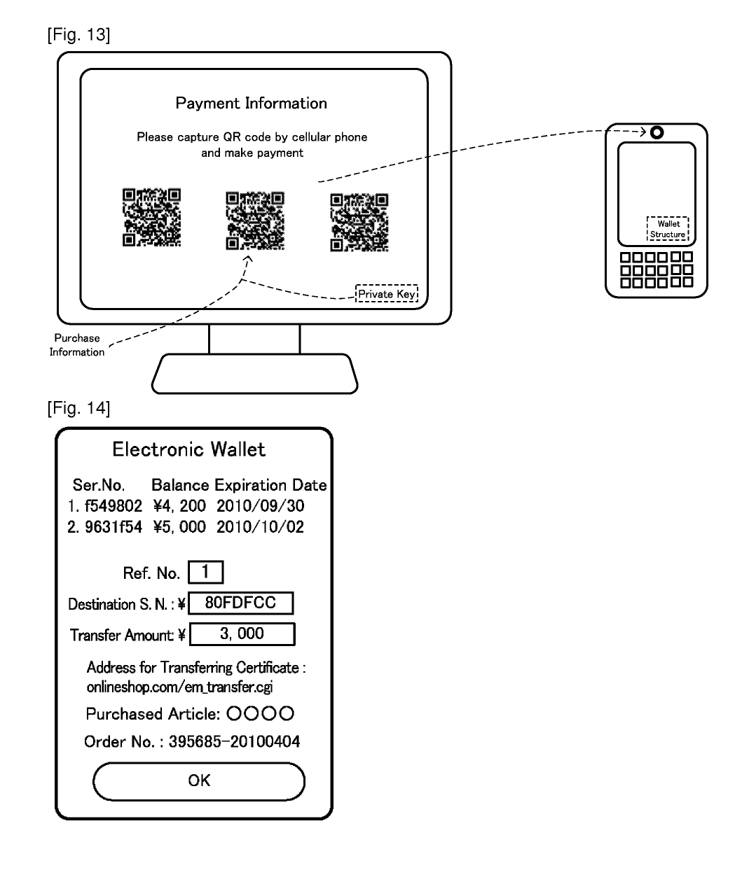

If the user designates the use of electronic money for the payment at an online shop through the PC, the server of the online shop transmits the serial number of the payee electronic wallet, the amount payable, the URL for transmission of a transfer certificate, and the purchase information such as the name of commodity, the order number, and so on. The plug-in receives the purchase/payment information, converts this information and the private key stored in the PC into QR code in the form of multiple symbols, and displays the multiple symbols of QR code in a payment screen as illustrated in FIG. 13.

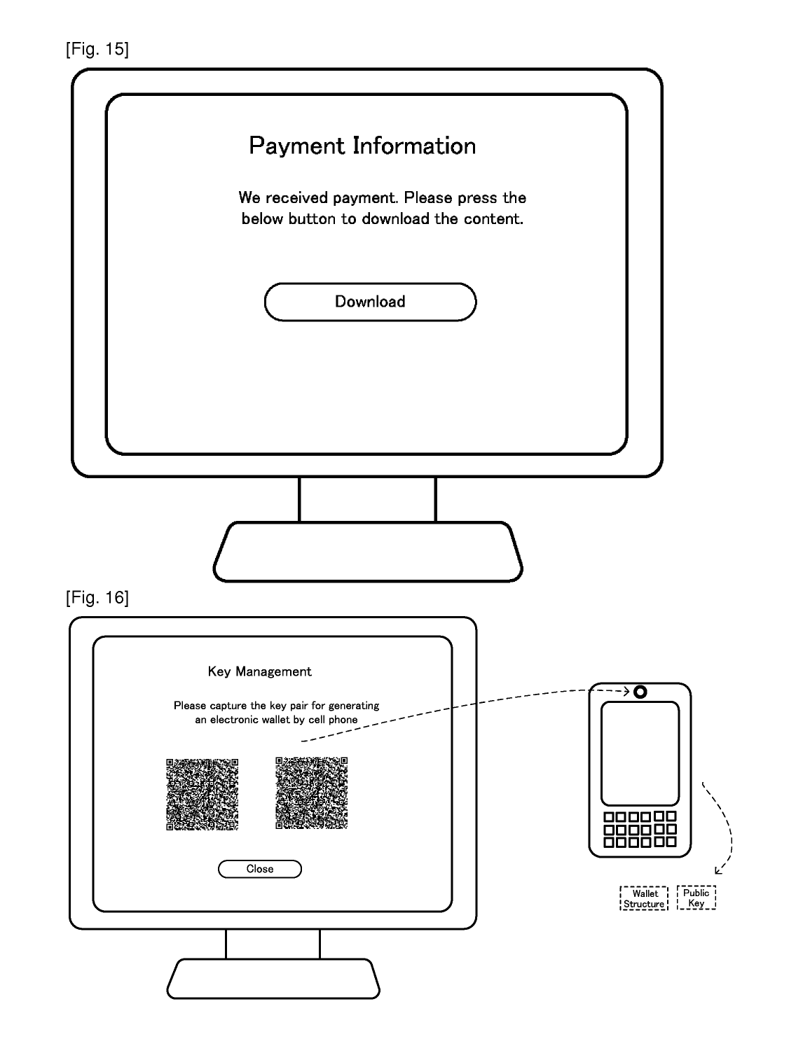

The buyer invokes the above application in the cellular phone, and captures the QR code displayed on the screen of the PC. The specification of the purchase/payment is displayed on the screen of the cellular phone as shown in FIG. 14. If there are a plurality of electronic wallets, the application automatically selects one of them. The buyer confirms the specification, and click an “OK” button after switching the electronic wallet for use in paying if desired. The application then accesses the proxy signing server, transfers the amount payable of electronic money to the payee electronic wallet, and transmits the transfer certificate to the online shop at the URL together with the order number. After verifying the received transfer certificate, the online shop displays that the payment has been confirmed, and makes it possible to download online content if the commodity is the online content as illustrated in FIG. 15.

(Using Electronic Money at Real Shop)

The cellular phone as described above can be used for payment in this electronic money at a real shop by running the above application. The prices of items are indicated by barcode or QR code in the real shop receiving the electronic money for payment. Of course, it is possible to manually input the prices. Also, the serial number of the electronic wallet of the shop and the URL of a payment assistant server are indicated by QR code at the shop. The URL includes also the identification number of the real shop.

The customer puts goods in a shopping basket after reading the QR code with the cellular phone. The prices are summed up in the cellular phone. Before going to the register, the customer accesses the proxy signing server through the cellular phone and makes payment to the electronic wallet of the shop. Then, the cellular phone accesses the payment assistant server and transmits the received transfer certificate together with the identification number of the real shop. In response to this, the payment assistant server confirms and verifies the receipt time of the transfer certificate, and returns a payment number which is then displayed on the cellular phone. At the same time, the payment assistant server transmits the payment number and the transfer amount also to the register of the shop together with the serial number of the payer electronic wallet with reference to the identification number of the real shop. If there is no register available for this purpose as in a private shop, this payment information is transmitted to a cellular phone of the store clerk which is registered in advance in the server. Accordingly, after calculating the payment amount at the register, the customer has only to tell the payment number to the clerk instead of paying real cash. The payer can be more surely identified by confirming the serial number. If there is miscalculation, settlement can be made by cash.

(Purchase of Electronic Wallet 2)

In the case of the above purchase of electronic wallet, even though temporarily, all the data elements related to an electronic wallet including the private key, the public key and the electronic wallet structure are handled by the PC. It is therefore preferable to perfectly separate the private key and the electronic wallet structure in order to enhance the security. In what follows, one example of such a method will be explained. A plug-in for handling an electronic wallet is installed in a PC. Also, an application for handling an electronic wallet is installed in a cellular phone. This application may be a dedicated application or may function also as a Web browser.

First, the plug-in of the PC generates a pair of public and private keys, and calculates the self-signature by signing the public key with the private key. The key pair is given a unique identification number (to be a reference number as described above). The public key is displayed as QR code (FIG. 16) together with this identification number. On the other hand, the private key is saved in the disk and managed by the PC in association with the identification number.

The buyer captures the displayed public key and identification number into the cellular phone together with the identification number.

Next, the buyer accesses the online shop from the cellular phone, selects an electronic wallet to be purchased by designating a deposit amount, and uploads the public key and the self-signature stored in the cellular phone. This process is performed by the application installed in the cellular phone. The online shop verifies the self-signature, and makes the cellular phone to display the screen for payment. Thereafter, payment can be performed in the same manner as when purchasing usual commodity such as online content.

After confirming the payment, the online shop transfers electronic money to a new electronic wallet corresponding to the received public key. The transfer certificate is downloaded and managed by the cellular phone as an electronic wallet structure. The electronic wallet can be used through the cellular phone as described above by the use of the private key stored in the PC.

(Other Examples of Purchase/Using of Electronic Wallet)

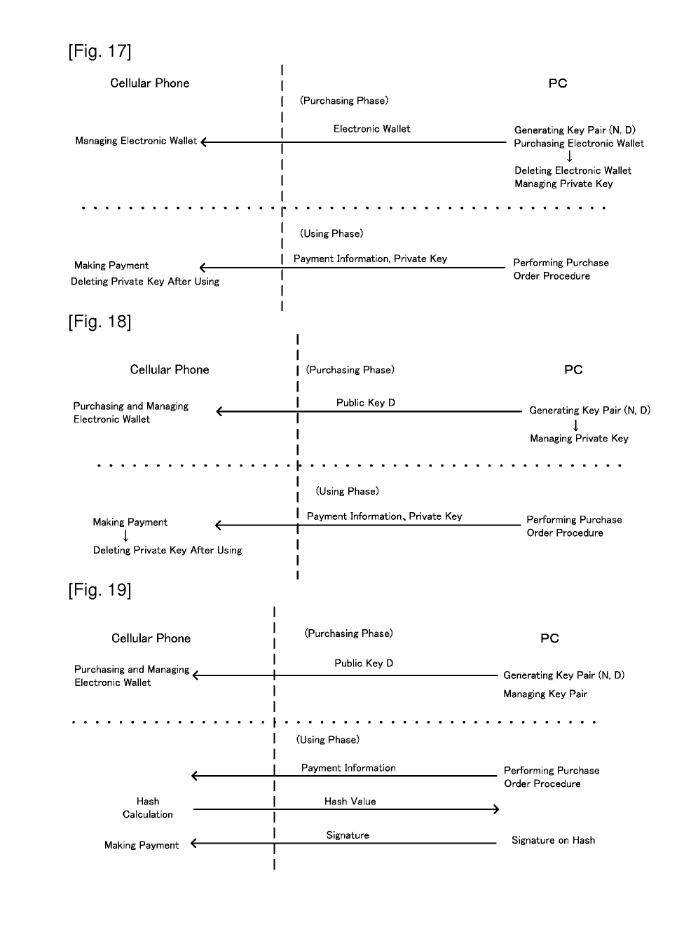

FIG. 17 shows the purchase of electronic wallet 1. In this case, the PC generates a key pair and purchases the electronic wallet which is transmitted to the cellular phone and deleted from the PC. FIG. 18 shows the purchase of electronic wallet 2. In this case, the cellular phone performs the procedure of purchasing an electronic wallet by using the public key which is transmitted from the PC. In both cases, the cellular phone performs the procedure of purchasing a commodity by using the electronic wallet and the private key which is transmitted from the PC and deleted from the cellular phone after using the electronic wallet. The private key and the electronic wallet can be more perfectly separated as follows.

While the payment information and the private key are transmitted from the PC to the cellular phone in the cases shown in FIG. 17 and FIG. 18 only the payment information is transmitted in the case shown in FIG. 19. Then, on the basis of the payment information and the electronic wallet structure, the cellular phone calculates and transmits the plaintext (as pre-processed such as hashing and padding) to be signed with the private key to the PC. The PC signs the received plaintext with the private key and returns the signature to the cellular phone. The cellular phone makes payment with the received signature. In this case, the public key is stored in the PC together with the private key for generating the signature.

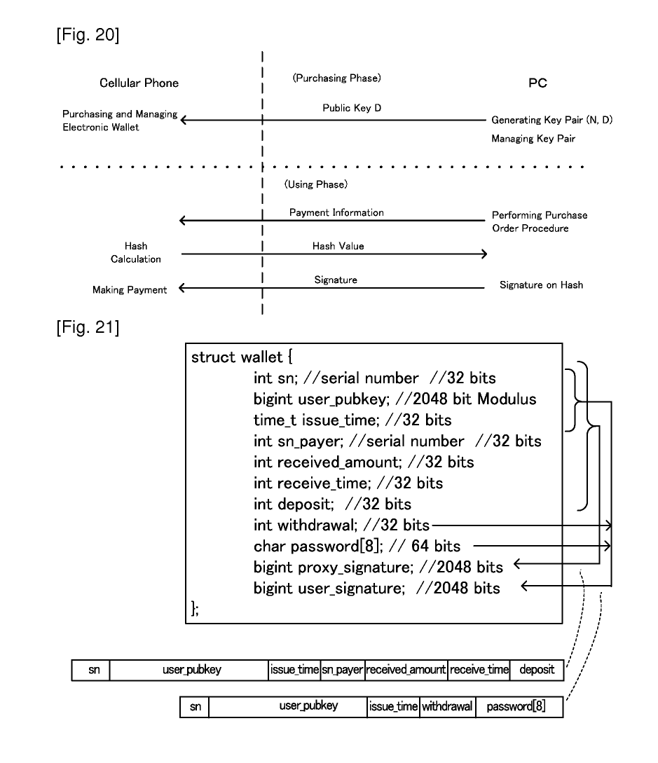

On the other hand, in the case shown in FIG. 20, a key pair is generated by the cellular phone, and the public key is transmitted to the PC. It may take certain time for less powerful cellular phones to generate a key pair. However, key generation is required only when purchasing an electronic wallet, and therefore it is not a major obstacle. The PC purchases an electronic wallet with this public key, and manages the electronic wallet. When the electronic wallet is used, the PC calculates the plaintext (as pre-processed such as hashing and padding) to be signed and transmits the plaintext to the cellular phone. The cellular phone signs the received plaintext with the private key and returns the signature to the PC. This signature is used to make payment on the PC side.

In FIG. 18 and FIG. 20, communication is needed both from the PC to the cellular phone and vice versa. The communication from the PC to the cellular is performed by capturing QR code with the camera of the cellular phone, and therefore it is easy to implement the system and enhance the security. If the PC is provided with a camera, the communication from the cellular phone to the PC can be performed in the same manner. If the PC is not provided with a camera, the communication from the cellular phone to the PC can be performed through the Internet. Namely, the QR code may include also an email address of the PC such that the cellular phone can transmit necessary data to the PC through email. Alternatively, just after displaying the QR code, the electronic wallet program running on the PC may listen on a predetermined port. The number of the port is contained in the QR code as well as the IP address of the PC. The cellular phone can therefore transmit necessary data to the PC through the IP address and port.

(Example Using Electronic Money Only With PC 1)

If electronic money can be used only with a PC, it is very convenient. For this purpose, secret information is shared between the proxy signing server and the user. However, this secret information plays only an auxiliary role, and shall not impose any additional security burden on the proxy signing server. In this case, as illustrated in FIG. 21 a password member “password” is added to the electronic wallet structure shown in FIG. 7 as the shared secret information. A password pw is set to the password member is set by the user. In what follows, differences from the flow chart of FIG. 10 will be explained.

Namely, in the step U1 of FIG. 10, the user further transmits a pair of passwords together with the transfer request. The proxy signing server receives the pair of passwords, and compares the first password of the pair with the password member of the electronic wallet unless the password member of the electronic wallet has been set to NULL(0) which means that no password is used. If the first password does not match the password member which is not NULL, the transfer request is rejected. If the first password matches the password member, the transfer request is accepted. In the step U4 of FIG. 10, the user generates the user signature {s1, n1, t1, w1+v+f, pw}p1 by the use of this first password “pw”. That is to say, the user certifies that the password pw is set. The password member is updated by the other password of the pair in the step S8 of FIG. 10, such that the user can easily update the password. Accordingly, even if all the information saved in the PC is stolen as long as the password is kept secret, the password level security can be maintained. However, the proxy signing server shall not be responsible for any damage on the electronic wallet.

(Example Using Electronic Money Only With PC 2)

In the previous example using electronic money only with PC, the electronic wallet structure includes the secret information for authenticating the accessing user. It is possible to exclude the secret information from the electronic wallet structure. This can be implemented by generating the secret information for each accessing user from the MAC unit shown in FIG. 36 which will be described below. For example, if authentication is needed, the secret information is generated by inputting the serial number s to the MAC unit as the upper 24 bits of the key K while the remaining lower 488 bits are set to 0. The authentication may be performed by comparing a few digits, which is input by the user as a password, with the corresponding lower bits of the secret information.

(Example Using Electronic Money Only With Cellular Phone)

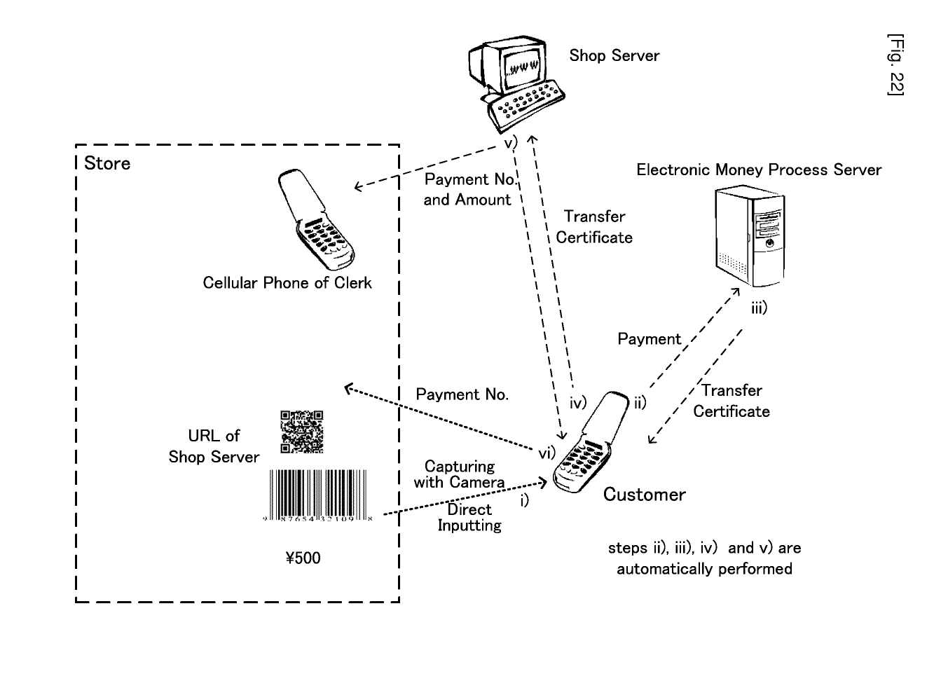

Since there is only few malware infected in cell phones, it may be reasonable to purchase an electronic wallet and use electronic money through a cellular phone (FIG. 22). Payment can be made with the cellular phone by the use of QR code as has been discussed above, followed by telling the payment number at the register. When the cellular phone is lost, the electronic money would be stolen and used. However, if the electronic money is comparable with the cellular phone itself by value, it is a realistic option that an electronic wallet is saved in the cellular phone in a self-contained manner. Incidentally, steps ii), iii), iv) and v) in FIG. 22 are automatically performed by software as a sequence after inputting price information to the cellular phone.

(Collection of Log Data)

The asset of each user is preserved only by the information of electronic wallet itself as long as the user exclusively possesses the private key. However, even if the private key of the proxy signing server is not leaked, some damage may be caused on the issuer when the information stored in the database of the proxy signing server is lost or tampered. For example, if user signatures are deleted from the database of the proxy signing server, it becomes impossible to prove the withdrawal amounts against untrusted requests.

In such a case, if a transaction log is recorded, the database of the proxy signing server can be restored. Preferably, each time electronic money is transferred, the issuer server 2 saves the transmitted deposit certificate and the received withdrawal certificate in the transaction log. This makes it possible to prove the withdrawal amount even if the database of the proxy signing server is damaged.

Furthermore, since the log information is very simple, a variety of information can be easily extracted therefrom by statistical process. For example, while continuously monitoring the flow of electronic money, it is possible to estimate economical development and detect questionable flows of electronic money.

(4) Other Transaction Examples

(Preventing Repeated Use of Tickets)

It is assumed that a concert ticket is purchased by electronic money. As has been discussed above, the buyer transfers a predetermined amount of electronic money to the electronic wallet of a ticket seller site (payee electronic wallet), and transmits the transfer certificate to the ticket seller site.

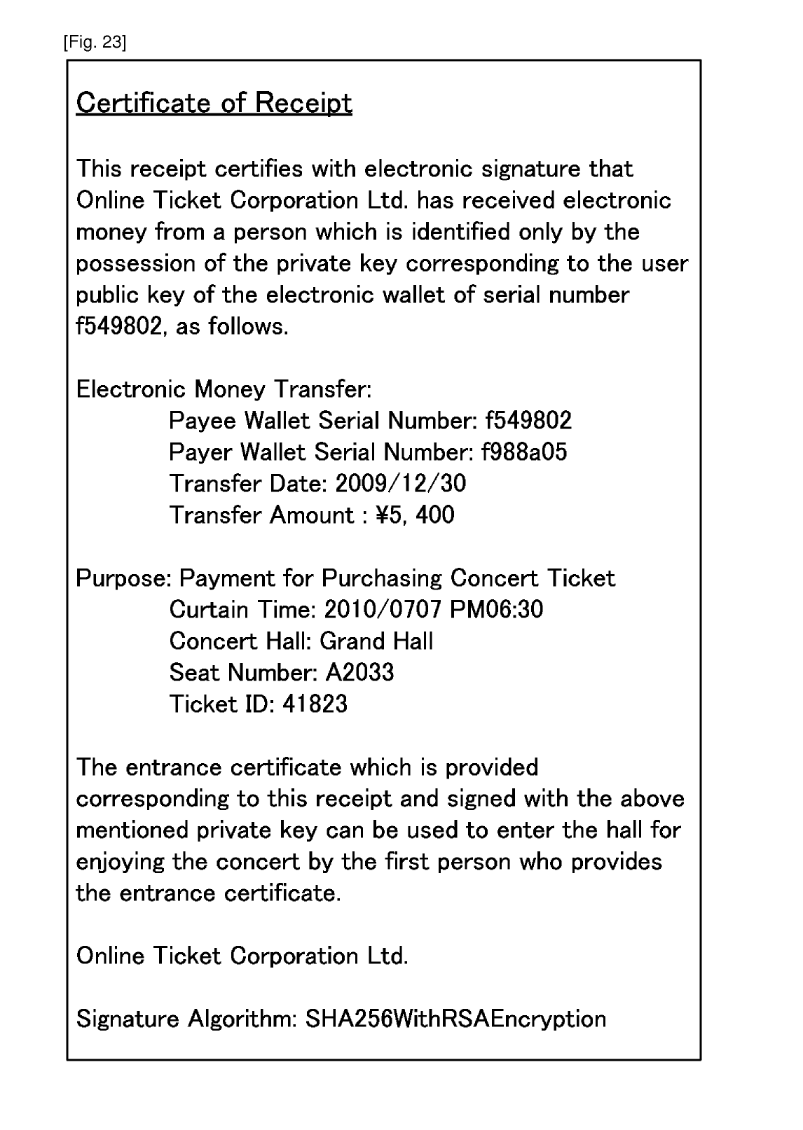

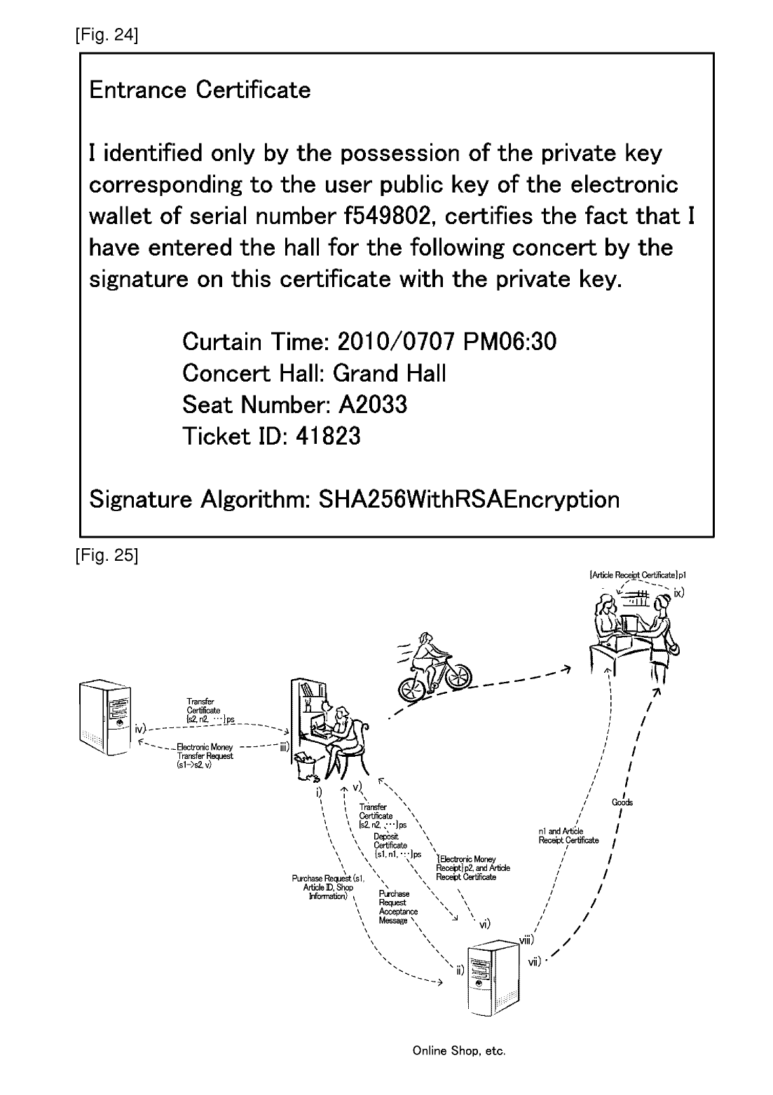

In this case, when the transfer certificate is transmitted, the deposit certificate of the electronic wallet of the buyer for use in making payment is also transmitted to the ticket seller site. This is because the deposit certificate is used as the public key certificate of the buyer. After confirming the transfer certificate, the ticket seller site issues an electronic money receipt and an entrance certificate as shown in FIG. 23 and FIG. 24 respectively. The electronic money receipt is signed by the ticket seller with the private key corresponding to the public key of the payee electronic wallet, which is accompanied with a public key certificate.

The electronic money receipt is provided for certifying that electronic money has been received as payment for the ticket described therein, and that permission to enter the concert hall is granted to one having the entrance certificate which is signed with the private key corresponding to the public key certified by the deposit certificate of the payer electronic wallet. Also, the buyer can use the entrance certificate as a digital ticket by making signature.

For example, the buyer prints out the QR code of the signature on a paper slip together with the identification number of the ticket. This slip is used as the digital ticket which is shown at the gate where a QR code reader is placed. It is confirmed at the gate whether or not there is a person having already entered in correspondence with the same identification number.

If there is a person having already entered, entrance is refused by showing the signed entrance certificate which has been received from the preceding person. In other words, on the basis of the concept of the present invention, the preceding person is regarded as a rightful user.

If there is no such a person, the signature of the entrance certificate is scanned to confirm that the signature is true, and if it is true the entrance is permitted. The signed entrance certificate is saved as the evidence that a person has already entered in correspondence with the identification number. The QR code reader can be implemented by a netbook or cellular phone of the clerk provided with a camera and connected to the Internet. The issued entrance certificate, the plaintext (as pre-processed such as hashing) thereof and the corresponding public key of each ticket are downloaded to this netbook or cellular phone from the ticket seller site, and used to verify the signature of the entrance certificate as provided. By this configuration, the same digital ticket is prevented to be repeatedly used.

This method can be applied to reserved or non-reserved tickets on railway, buses, airplanes and so forth in the same manner.

(Over-The-Counter Sales of Electronic Wallet)

Next is the description of selling electronic wallets at a brick-and-mortar shop such as a convenience store. The user who wants to purchase an electronic wallet accesses an SSL site of the shop through a PC and enters an order to buy an electronic wallet. The order contains a user public key and a deposit amount of the electronic wallet to be purchased. While the private key is saved in the PC, the payment is not made at this site.

In response to this order, the site of the shop issues an order number having an expiration date. The shop's site only saves the information of the purchase order but does not perform any process relating to electronic money. The purchase order is deleted after the expiration date, e.g., three days has expired.

After ordering, the user goes to the shop, shows the order number and makes a predetermined amount of payment. The shop receiving the payment transmits the payment information to the shop's site where electronic money is transferred to a new electronic wallet from the electronic wallet of the shop in accordance with the order information corresponding to the order number. The serial number of the new electronic wallet is printed on the receipt given to the user.

Thereafter, the user can download the structure data of the new electronic wallet from the shop's site with reference to the serial number and the order number. Downloading is performed with a cellular phone. The downloaded electronic wallet can be used as described in the using phase of FIG. 17, FIG. 18 or FIG. 19. Meanwhile, the payment amount is the amount of electronic money in the electronic wallet plus the charges payable to the proxy signing server and the shop. By this method, even person having no credit card such as teenager and colleger can purchase an electronic wallet.

(Anonymous Purchase of Tangible Goods)

The above electronic money can be used to anonymously purchase digital content by downloading. However, when purchasing tangible goods such as books and commodities, the delivery information such as the residence and name is indispensable even if payment can be anonymously made.

The following is the description of receiving purchased tangible goods on an anonymous basis. In this case, it is assumed that the goods is received at a brick-and-mortar store such as a convenience store. Namely, when purchasing tangible goods at an online shop, the buyer selects receiving at a brick-and-mortar shop by designating the goods and a specific store for receiving. The specific store may be designated, e.g., from among convenience chain stores listed in a page of the online shop site. Furthermore, a reception period is designated such that the buyer can receive the goods in this period, for example, from Nov. 10, 2010 to Nov. 14, 2010. The purchase information is transmitted to the online shop together with the serial number s1 of the buyer (i of FIG. 25).

In response to this, the online shop transmits a purchase request acceptance message including a purchase number, the purchase specification, and the serial number of the electronic wallet s2 of the online shop for receiving payment (ii of FIG. 25). The buyer transmits a transfer request (s1->s2, v) for transferring electronic money as described above (iii of FIG. 25), and receives a transfer certificate {s2, n2, . . . }ps (iv of FIG. 25).

The buyer then transmits the deposit certificate {s1, n1, . . . }ps of the electronic wallet of the buyer together with the transfer certificate (v of FIG. 25). The online shop confirms the received transfer certificate, and issues an electronic money receipt and an article receipt certificate (vi of FIG. 25). This electronic money receipt is signed with the private key p1 of the online shop and certifies the right of the buyer to receive the goods together with the serial numbers of the payer and payee electronic wallets and the specification of the transaction including the receipt of the transfer amount. Also, the electronic money receipt contains the information about the designated store and the reception period. The online shop then ship the goods (vii of FIG. 25).

On the other hand, the article receipt certificate is used to certify that the buyer has received the goods. The buyer signs the hash (SHA-256) of this file with the private key p1 of the above payer electronic wallet, and prints out the QR code thereof on a paper slip together with the article receipt certificate.

The buyer then goes to the store and shows a clerk the purchase number to receive the goods. The clerk confirms the goods kept in the store, and ask for the QR code ({article receipt certificate}p1). The QR code provided by the buyer (ix of FIG. 25) is verified by the use of the public key and the article receipt certificate downloaded from the online shop's site as the sender (viii of FIG. 25). If successfully verified, the goods is handed over. The signature is transmitted to the online shop's site and kept as the article receipt.

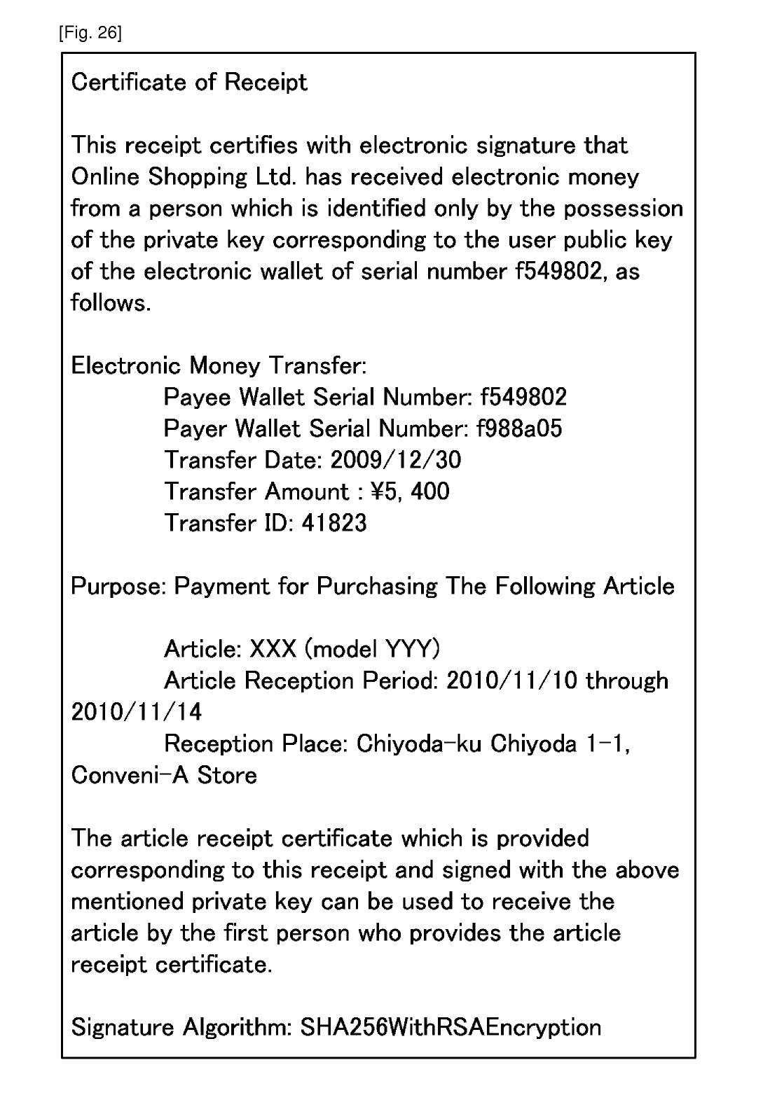

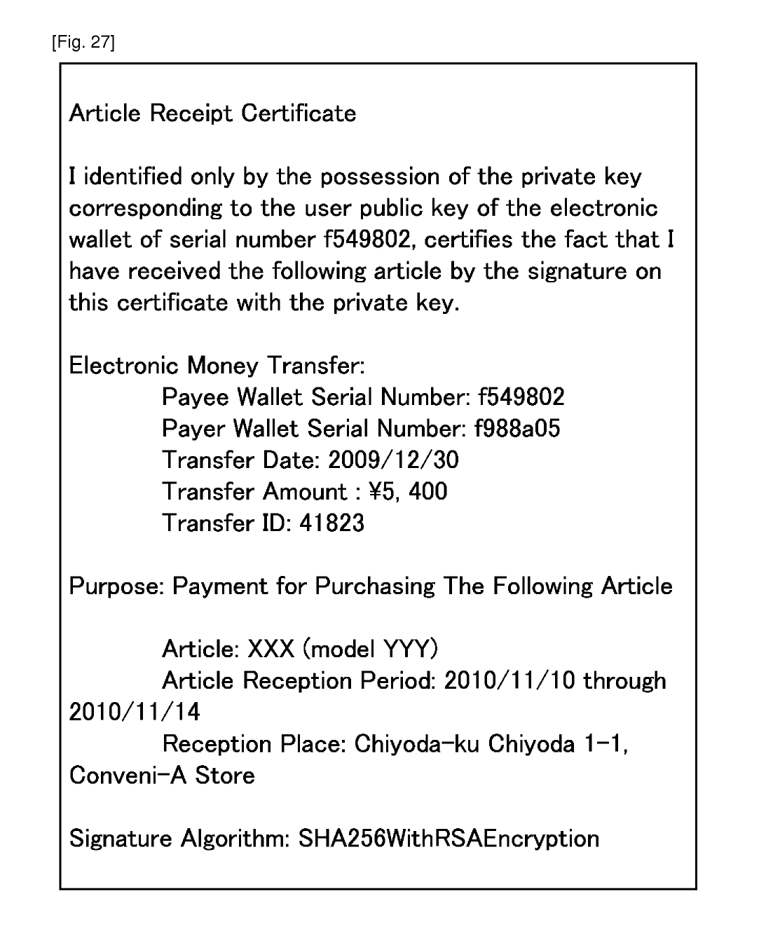

Examples of the electronic money receipt and article receipt certificate are shown in FIG. 25 and FIG. 26 respectively. The electronic money receipt shown in FIG. 26 guarantees the right to receive the commodity by the signature of the online shop. On the other hand, by the user signature made on the article receipt certificate shown in FIG. 27, while the user can prove that he is the buyer having the right to receive the commodity, the online shop can prove that the commodity has been received. The public key which can be used to verify the user signature is certified by the deposit certificate of the payer electronic wallet.

3. Exemplary Modification

(1) Controlling Circulation

It is preferred to impose restrictions on the transfer between electronic wallets depending upon the application. For example, like prepaid cards, the transfer of electronic money may be prohibited between electronic wallets, both of which are not the electronic wallet of the issuer. Also, in the case where an Internet shopping mall provides this service, the users which can be payees may be limited to the member.

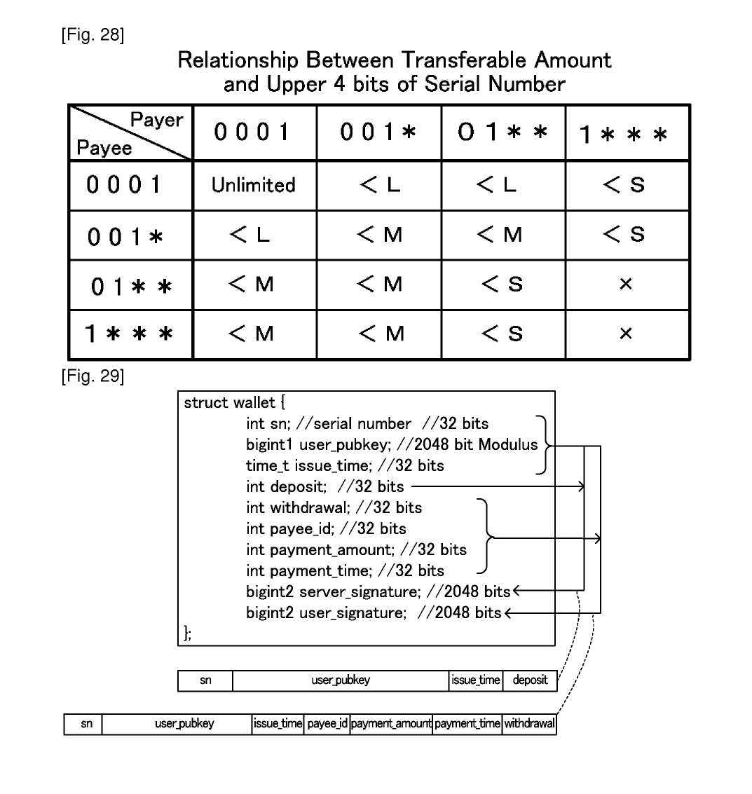

In a more generalized scheme, as illustrated in FIG. 28, the electronic wallets can be classified into user levels in accordance with upper bits of the serial number. Namely, the electronic wallets of Level 1 are given serial number having upper four bits of “0001”. For example, if the user public key of an electronic wallet is associated with the public key certificate, the electronic wallet is of Level 1. Likewise, the electronic wallets of Levels 2, 3 and 4 are given serial number having upper four bits of “001*”, “01**” and “1***” respectively, where “*” can be either “0” or “1”. Serial numbers having upper four bits of “0000” are not used or reserved.

For example, if the personal information of the owner of an electronic wallet is registered in association with the electronic wallet, the electronic wallet is of Level 2. Also, if there is buyer's information when purchasing an electronic wallet such as credit card purchasing, the electronic wallet is of Level 3. Other anonymous electronic wallets are of Level 4. For each level, a maximum balance may be predetermined. FIG. 28 relatively shows the maximum amounts of transferable electronic money from/to the electronic wallet in each level. Electronic money can be transferred without limit between electronic wallets both in level 1, but no electronic money can be transferred between electronic wallets both in level 4. In the figure, the maximum amounts of transferable electronic money decreased in the order <L, <M and <S. In the case of the electronic money process server 1 shown in FIG. 6, inappropriate transfer requests are rejected by the issuer server 2 in accordance with the above restriction, and shall not be transferred to the proxy signing server 3.

(2) Implementation Without Circulation

In this implementation, a broker issues electronic money which can be purchased by consumers. The consumers can use the electronic money only at member stores. The member store can redeem the electronic money received of sales with the broker. Namely, the consumer designates a member store to be the payee, signs electronic money in own electronic wallet, and transmits the signed electronic money (withdrawal certificate) to the server of the broker. The balance of the electronic wallet is thereby reduced, but the electronic money is not transferred to any other electronic wallet.

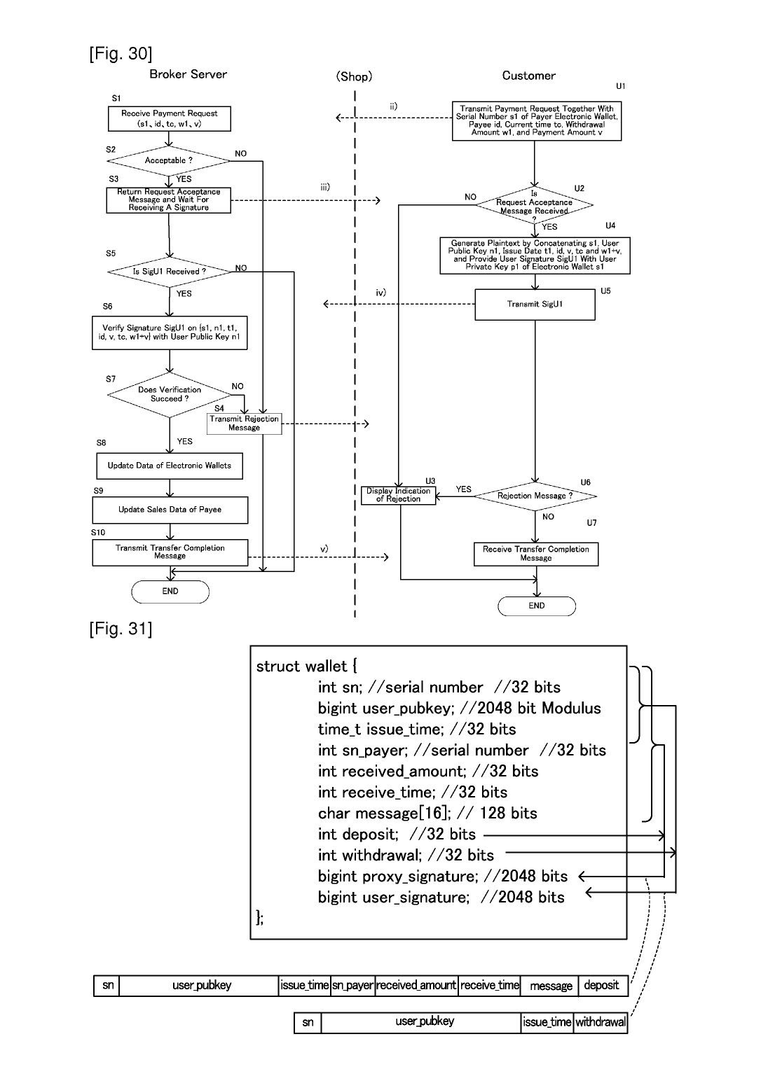

FIG. 29 shows the electronic wallet structure of this example. The wallet structure includes “payee_id” as the payee ID, “payment_amount” indicative of the last consumed amount of electronic money, the payment time “payment_time” indicative of the date and time the payment is made in addition to the electronic wallet structure of FIG. 8. The broker follows the following payment protocol as shown in FIG. 30 during communication with a consumer for making payment at a shop. However, the shop intervenes between the consumer and the broker. The consumer sends data to the shop server which confirms the data and transfer it to the broker server. Also, the broker server returns data to the shop server which confirms the data and transfer it to the consumer. However, the consumer can purchase electronic money by directly communicating with the broker server in the same manner as the previous example.

First, the user who wishes to make payment in electronic money sends a transfer request (U1) through a consumer terminal together with the serial number s1 of the payer electronic wallet, the identification number id of the payee (shop), the current time tc to be the payment time, a withdrawal amount w1, and a payment amount v. The broker server receives this transfer request (S1), and determines whether or not this transfer request can be accepted (S2). If accepted, the broker server holds an exclusive lock on the record of the electronic wallet s1 in the database of the broker server, transmits a transfer request acceptance message to the consumer terminal (S3), and waits for receiving a signature from the consumer terminal.

Conversely, if the transfer request cannot be accepted, the broker server returns a rejection message (S4). For example, the transfer request is rejected if the received withdrawal amount w1 is inconsistent with the record of the database of the broker server.

The rejection message is sent to the consumer terminal together with the reason. If the received withdrawal amount w1 is smaller than that recorded in the database of the broker server, the user signature of the electronic wallet structure is send as evidence to the consumer terminal together with the recorded withdrawal amount w1. If not accepted (U2, NO), an indication is displayed in the consumer terminal (U3).

After receiving the transfer request acceptance message (U2, YES), the consumer terminal generates plaintext which consists of s1, the user public key n1, the issue date t1, id, v, the current time tc as “payment_time” and w1, which are concatenated together. The consumer terminal then generates a user signature {s1, n1, t1, id, v, tc, w1+v}p1 by signing the plaintext as SigU1 (U4). Incidentally, this concatenation is to simply link data together in the form of a bit sequence as described above. This user signature SigU1 is transmitted to the broker server (U5) together with the plaintext as a withdrawal certificate.

If the signature SigU1 is not received within a predetermined period (S5, NO), the broker server terminates the process. If the signature SigU1 is received (S5, YES), the broker server verifies the received signature SigU1 of the plaintext {s1, n1, t1, id, v, tc, w1+v} by the use of n1 (S6). If verification fails (S7, NO), a rejection message is send to the consumer terminal together with the reason followed by terminating the process. Receiving the rejection message (U6, YES), the consumer terminal displays an indication of the rejection followed by terminating the process.

If verification succeeds (S7, YES), the data of the electronic wallet s1 is updated (S8). Namely, the payee, payment amount, payment time, withdrawal amount w1 and user signature of the electronic wallet s1 are updated to id, v, tc, w1+v and SigU1 respectively. On the other hand, the sale data corresponding to the payee id managed by the broker server is updated (S9). Finally, the broker server completes the electronic money payment process by transmitting a payment completion message to the consumer terminal (S10). After receiving the payment completion message, the consumers ends the process.

The shop server saves the withdrawal certificates and thereby can certifies the sale. Redemption of electronic money is made by a known method on the basis of the withdrawal certificates saved by the shop server, for example, for monthly settlement. Also, the broker server can use the withdrawal certificates to certify the consumption of electronic money performed by the users. With respect to after-the-fact troubles, the shops and the broker are based on the relations of trust in the same manner as conventional relations. However, such trust relationship is not required between each consumer and the broker (shops) as explained above. Anyway, the broker server need not make a signature for each transaction so that the computational load of the server can be substantially reduced.

(3) Input Error Prevention

When transferring electronic money, the serial number may be entered manually. In the case of bank transfer, the name of payee is usually checked to prevent erroneous transfer due to a wrong account number. The above electronic money transfer is performed only on the basis of the payee serial number, and therefore it is preferred to provide a means for detecting input error.

The probability of erroneous transfer can be substantially reduced by extending the serial number as follows. Namely, a hex number (one letter from 0 to F) is added as an error detection symbol to the last letter of the above hexadecimal serial number. The extended serial number is used as an electronic wallet number. This hex number is determined to satisfy the following equation where SUM(si) is the sum of the digits (0 through F) of the electronic wallet number.

SUM(si)mod 16=0

For example, if the serial number is f549802, f5498025 is used as the corresponding electronic wallet number because f+5+4+9+8+0+2+5=16d*3. Electronic wallet numbers are used among users rather than serial numbers.

Accordingly, when transferring electronic money, a user inputs an electronic wallet number to his terminal as the number identifying the payee electronic wallet. The terminal converts each letter of the electronic wallet number into an integer, and calculate SUM(si)&0xf. If the result is not 0, the terminal displays an indication that the input number is wrong to prompt the user to enter again. If the result is 0, the error detection symbol is removed from the electronic wallet number, and the above process is performed.

The probability of erroneous transfer can thereby be substantially reduced even if the serial number is manually input. For example, if there is one wrong letter in the input number, the user is always notified of the error. Also, if there are two or more wrong letters, the probability of failing to detect error is about 1/16.

(4) Messages

As shown in FIG. 31, the electronic wallet structure may include a member “message” in which a message can be written by the payer. Specifically, the payer can add a message (up to 16 bytes in this example) to a transfer request, and the message is written to the “message” member which is saved at least in the record of the proxy signing server. This member is included into plaintext to be proxy signed. It is therefore certified that this message has been written by the payee.

(5) Multiple Proxy Signing Servers

There may be a plurality of proxy signing servers which can be cooperated. The plurality of proxy signing servers can disperse the load on these servers. Furthermore, the system can be smoothly updated by generating a new electronic wallet in a newer proxy signing server with a new key pair. The proxy signing server in which all the electronic wallets have been expired is reset. Alternatively, the electronic money transfer may be performed between two different implementations managed by different providers. Anyway, the proxy signing servers can be distinguished by upper bits of the serial number.

For example, electronic money can be transferred from an electronic wallet managed by one proxy signing server to an electronic wallet managed by another proxy signing server as follows.

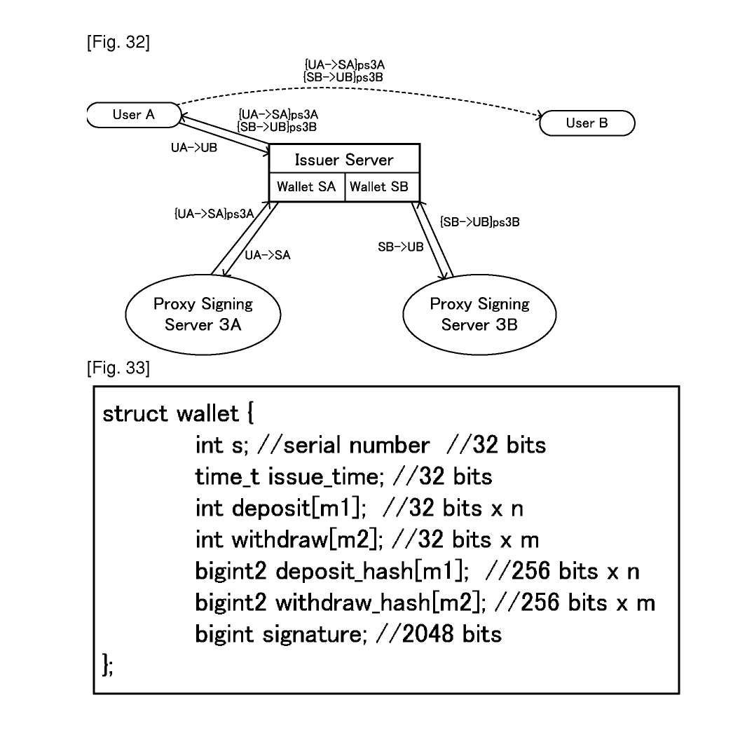

As shown in FIG. 32, it is assumed that user A wants to transfer electronic money from an electronic wallet UA managed by a proxy signing server 3A to an electronic wallet UB managed by a proxy signing server 3B. First, user A transmits a transfer request UA->UB to an issuer server which possesses an electronic wallet SA managed by the proxy signing server 3A to an electronic wallet SB managed by the proxy signing server 3B. The issuer server has issued electronic money in the proxy signing server B. Namely, the electronic wallet SB is an exceptional electronic wallet provided only for issuer. The electronic wallet SA may be either a usual electronic wallet or an exceptional electronic wallet provided only for issuer in the proxy signing server A. If the electronic wallet SA is a usual electronic wallet, this issuer server is not associated with the proxy signing server A which is associated with another issuer.

The issuer server divides the transfer request UA->UB into two transfer requests UA->SA and SB->UB which are transmitted to the proxy signing server 3A and proxy signing server 3B respectively. The issuer server then receives transfer certificates UA->SA and SB->UB from the proxy signing server 3A and proxy signing server 3B respectively.

In this case, since the receipt times of the transfer certificates UA->SA and SB->UB correspond, although indirectly, these transfer certificates indicate the transfer UA->UB. If the “message” member as described above is available in the electronic wallet structure, the transfer UA->UB can be exactly certified by writing an transfer ID to the “message” member in both the transfer certificates UA->SA and SB->UB.

Anyway, the issuer server transmits the transfer certificates UA->SA and SB->UB to user A who transmits them to user B. If the transfer SB->UB incurs no charge because the payer is the issuer, the transfer between different proxy signing servers incurs the same charge as the transfer within one proxy signing server. Also, if the serial number consists of eight hexadecimal digits, for example, the uppermost digit may be used to distinguish the proxy signing server and manage the electronic wallets uniformly.

(6) Reducing The Load On Proxy Signing Server

In the example 1, each transaction is performed by generating and verifying electronic signatures which requires substantial computational costs. The use of a plurality of high speed hardware units dedicated for performing signing and verifying processes at high speeds can be considered.

Also, it may be possible to reduce the signature generation time by using elliptic curve cryptography such as ECDSA as the algorithm of generating electronic signatures.

(7) Example Using No Transfer Certificate

The following is a description of the method of transferring electronic money using the electronic wallet structure shown in FIG. 8. It is assumed here that a user purchases goods at the online shop and make payment in electronic money. However, of course, this method can be applied to any situation of electronic money transfer.

If the use of electronic money is designated for the payment at an online shop, the user has to transmit the serial number of the payer electronic wallet, the withdrawal amount w1, the transfer amount v and the transfer charge f to the online shop. The online shop receives this information, and transmits this information to the proxy signing server together with the information of the payee electronic wallet as a transfer request. The proxy signing server returns a transfer request acceptance message if the transfer request is justifiable. The online shop transfers the acceptance message to the user. The user transmits a withdrawal certificate to the online shop, which transfers this withdrawal certificate to the proxy signing server. The proxy signing server confirms the withdrawal certificate, and returns a deposit certificate to the online shop. The online shop confirms the deposit certificate, and hands over the goods.

Needless to say, this payment method can be used with the proxy signing server using the electronic wallet structure shown in FIG. 7. This means that the online shop can select either this method or the method described in the above (Using Electronic Wallet).

### Example 2

1. Basic Configuration

(1) Hash

Since the proxy signing server has to generate an electronic signature every time electronic money is transferred, there may be a heavy load on the proxy signing server. In this example, electronic signature is generated only when creating an electronic wallet, and electronic money is transferred only by calculating hashes.

In advance of describing the example 2 in detail, the hash function and the hash chain will be explained. The hash function is a function which is considered to be a one-way function for use in cryptographic processes. Examples includes MD2, MD4, MD5, SHA, SHA-2 and SHA-3 which is a more secure hash function standard still in development.

Also, the hash chain is a series of hashes generated as follows. First, a random number R is generated and input to a hash function h( ) to obtain a calculation result (hash). The calculation result is input to the same hash function h( ) to obtain the next calculation result. This process is repeated predetermined times n to obtain a sequence of n calculation results. The sequence is indexed backward from 0 corresponding to the last calculation result to n−1 corresponding to the first calculation result. The random number R is indexed as n. As a result, the sequence is indexed k to form a hash chain h(k).

h(k)=h^{n-k}(R)

wherein k=0 to n, h⁰(R)=R.

The important feature of a hash chain is a one-way property. Namely, if h(i) is known, it is easy to compute h(j) where j<i. However, it is hard to calculate h(k) where k>i from h(i). h(0) is referred to as a root hash. Also, h(n) is referred to here as an original hash. If there are m hash chains which are associated with each other, the set of hash chains is collectively referred to as a hash chain vector.

(2) Symbol Definition

The following implementation example will be explained with symbols defined as follows.

i) If a symbol begins with a capital letter, the symbol stands for either a vector or a scalar. In other words, such a symbol can be interpreted as either a vector or a scalar. Each element of a vector is designated by a subscript. If symbols are interpreted as scalars, addition, subtraction and product can be performed in a usual manner.

ii) If a symbol begins with a lower-case letter, the symbol stands only for a scalar.

iii) The sum of A and B, i.e., A+B is a usual vector sum. Namely, if it is assumed that the dimension of the vector is m, that A=(A₁, A₂, . . . , Aₘ₋₁, Aₘ), and that B=(B₁, B₂, . . . Bₘ₋₁, Bₘ), A+B=(A₁+B₁, A₂+B₂, . . . , Aₘ₋₁+Bₘ₋₁, . . . , Aₘ+Bₘ).

iv) The difference between A and B, i.e., A−B is a usual difference vector. Namely, A−B=(A₁−B₁, A₂−B₂, . . . , Aₘ₋₁−Bₘ₋₁, . . . , Aₘ−Bₘ).

v) The product of A and B, i.e., A*B is the inner product of A and B. Namely, A*B=SUM(AₖBₖ), where SUM( ) indicates the summation with k as the index starting from 1 to m.

vi) If A(k) represents a chain of vectors indexed with k, i.e., if each element Aᵢ(k) is a hash chain indexed with k, a vector A(X) is defined with a vector X as follows.

$${A ( X )}_{1} = {A ( {X}_{1} )}_{1}$$

$${A ( X )}_{2} = {A ( {X}_{2} )}_{2}$$

$$…$$

$${A ( X )}_{m - 1} = {A ( {X}_{m - 1} )}_{m - 1}$$

$${A ( X )}_{m} = {A ( {X}_{m} )}_{m}$$

Also, A(0) is defined as a vector consisting of the root hashes of the hash chains respectively.

(3) Definitions of Related Data

electronic wallet s: electronic wallet to which serial number s is assigned

Hw(s): withdrawal hash chain vector which is a hash chain vector for withdrawing electronic money from electronic wallet s

Hd(s): deposit hash chain vector which is a hash chain vector for depositing electronic money into electronic wallet s

Xw(s): withdrawal index vector which is an index vector pointing to the last used hashes of the hash chains of Hw(s)

Xw(s): deposit index vector which is an index vector pointing to the last used hashes of the hash chains of Hd(s)

Ww(s): withdrawal weight vector which is a weight vector for use in calculating the cumulative total of withdrawn amounts as Xw(s)*Ww(s)

Wd(s): deposit weight vector which is a weight vector for use in calculating the cumulative total of deposited amounts as Xd(s)*Wd(s)

Lw(s): hash length vector which is a length vector of withdrawal hash chain vector Hw(s)

Ld(s): hash length vector which is a length vector of deposit hash chain vector Hd(s).

If the first and last values of the index of one hash chain are 0 and n respectively, the length of this hash chain is n. The lengths of the hash chains of Hw(s) and Hd(s) can be freely selected. On the other hand, when creating an electronic wallet s, at least one element of the initial vector of the index vector Xd(s) is usually a value greater than 0 in accordance with the initial value of the balance of the electronic wallet s.

Also, for each electronic wallet, different values of Ww(s), Wd(s), Lw(s) and/or Ld(s) may be given. However, in the following example, common values of Ww, Wd, Lw and Ld are used independent of the serial number for the sake of clarity in explanation. In the case where these values depend upon the serial number, Ww(s), Wd(s), Lw(s) and/or Ld(s) are included in the members of the electronic wallet structure.

(4) Electronic Wallet Structure

The electronic wallet structure of the example 2 is defined as shown in FIG. 33. Namely, the electronic wallet structure consists of seven members, i.e., “sn” (32-bit integer) which is the serial number as the identification number of this electronic wallet, “issue_time” (32-bit integer) which is the issue date and time, i.e., the date and time when the electronic wallet is issued, “deposit[m1]” (32-bit integer*m1) which is the vector Xd(s), “withdraw[m2]” (32-bit integer*m2) which is the vector Xw(s), “deposit_hash[m1]” (256-bit integer*m1) which is the vector Hd(s, Xd(s)), “withdraw_hash[m2]” (256-bit integer*m2) which is the vector Hw(s, Xw(s)), and “signature” (2048-bit integer) which is a broker signature. m1 and m2 are positive integers which may be the same or different and are the dimensions of the deposit and withdrawal hash chain vectors respectively.

In FIG. 33, 256-bit integer type is indicated as “bigint2”, which will be processed as an array of primitive type integer by programs.

Each instance of the electronic wallet structure is saved by both the user of the corresponding electronic wallet and a broker server which is the counterpart of the proxy signing server as described above. The broker server provides the broker signature, when each electronic wallet is generated, by signing the hash calculated by processing the serial number s, the issue date, the root hashes Hd(0) of the deposit hash chain vector and the root hashes Hw(0) of the withdrawal hash chain vector concatenated together as a bit sequence in accordance with the hash function SHA-256.

Incidentally, if there is no confusion, the serial number is omitted from the description of this example. Accordingly, the balance of the electronic wallet can be calculated from the values of the structure members corresponding to the electronic wallet on the basis of the following equation. The balance must be always positive.

Xd*Wd−Xw*Ww

Undisclosed withdrawal hashes are generated and kept secret by the owner of the electronic wallet with self-responsibility before using. Undisclosed deposit hashes are generated and kept secret by the broker server with self-responsibility before using. A payer user transmits undisclosed withdrawal hashes to the broker server as electronic coins. The broker server saves the received electronic coins as the evidence that these coins have been already used, and transmits corresponding deposit hashes as electronic coins to the payee user in place of the payer's coins.

The original hashes of the deposit and withdrawal hash chains are information related to the electronic wallet. However, these values are not the member of the electronic wallet structure. This is because these values are uniquely corresponding to the above electronic wallet structure, because the above electronic wallet structure is self-contained data representing the current state of an electronic wallet, and because these values serve only as devices for using the electronic wallet. In the following example, a single private key can be used to calculate all the deposit hashes so that it is not needed to save particular data for deposit hashes. However, it is also possible to prepare a random number for calculating deposit hashes each time an electronic wallet is generated in the broker server. In this case, the random number has to be saved in association with the instance of the electronic wallet structure corresponding to each electronic wallet.

(5) Specification Example

An example of the specification of the electronic wallet structure is as follows. The number of the hashes of the withdrawal hash chain is 3. The hash chain lengths Lw are (200, 100, 50). The number of the hashes of the deposit hash chain is 3. The hash chain lengths Ld are (200, 100, 50). The withdrawal weights Ww are (10, 100, 1000) in yen, and the deposit weights Ww are (10, 100, 1000) in yen. In this case, when an electronic wallet is created with electronic money of 5,000 yen, the initial deposit index vector may be selected to be (0, 0, 5), (50, 15, 3) or the like.

The hashing algorithm for generating hash chains is SHA-256. The hashing algorithm of generating broker signatures is SHA256WithRSAEncryption. The expiration date of the electronic wallet is one year from the issue date thereof.

The above specification is described in a certificate of the system provider which can be downloaded with the public key certificate issued by a CA. Anyway, like the example 1, the system is configured such that the user can prove the validity of electronic money only on the basis of the data the user possesses.

2. Using Electronic Money

Also in this case, the communication between the user and the broker server is completed within one SSL session. However, only server authentication is performed, but client authentication is not performed by SSL.

(1) Creating electronic wallets

The broker server creates an electronic wallet in response to a request from a user. First, the broker server receives an initial deposit index vector Xd(s) and the root hash vector Hw(0) of the withdrawal hash chain from the user. Then, the broker server determines a serial number s, and generates the root hash vector Hd(s, 0) of a deposit hash chain.

The broker server provides a broker signature {s, t, Hd(s, 0), Hw(s, 0)}ps by signing the serial number s, the current time t as the issue date, the root hash vector Hd(s, 0), and the root hash vector Hw(s, 0), which is Hw(0) as received, with the private key ps of the broker server. Furthermore, Hd(s, Xd(s)) is calculated in accordance with Xd(s) as received. In this case, the amount of electronic money v stored in the electronic wallet is calculated as v=Xd(s)*Wd.

Then, the serial number s, the broker signature and Hd(s, Xd(s)) are transmitted to the user. The user can construct the instance of the electronic wallet structure with the data. Then, in the instance of the electronic wallet structure generated in the database of the broker server, the elements of the withdrawal index vector Xw(s) are initialized by 0 respectively, and the above values are assigned to the other members of the instance.

(2) Transferring Electronic Money

The transfer request received by the broker server contains the serial number s1 of the payer electronic wallet, Xw(s1), Xd(s1), an increment Dw(s1) of Xw(s1), an increment Dd(s1) of Xd(s1), the serial number s2 of the payee electronic wallet, Xw(s2), Xd(s2), an increment Dw(s2) of Xw(s2), and an increment Dd(s2) of Xd(s2).

There is a predetermined charge f for transferring electronic money, for example, a predetermined percentage of the transfer amount. The charge f may be calculated in proportion to the computational cost required of the broker server.

First, the user transmits a transfer request to the broker server. In response to the received transfer request, the broker server accepts this transfer request if the following requirements are satisfied.

1) Xw(s1), Xd(s1), Xw(s2) and Xd(s2) are consistent with the records stored in the broker server.

2) Neither Xd(s1)+Dd(s1) nor Xd(s2)+Dd(s2) exceeds Ld, and neither Xw(s1)+Dw(s1) nor Xw(s2)+Dw(s2) exceeds Lw.

3) (Xd(s1)+Dd(s1))*Wd−(Xw(s1)+Dw(s1))*Ww>0

4) (Xd(s2)+Dd(s2))*Wd−(Xw(s2)+Dw(s2))*Ww>0

5) Dw(s1)*Ww−Dd(s1)*Wd=Dd(s2)*Wd−Dw(s2)*Ww+f

If either of the above requirements is not satisfied, the broker server returns a rejection message with a reason and terminates the process. For example, if Xw(s1) includes an element which is smaller than the corresponding data stored in the broker server, i.e., if it is requested to use a used hash, the broker server returns the used hash which has been already received.

When receiving a transfer request acceptance message, the user transmits Hw(s1, Xw(s1)+Dw(s1)) and Hw(s2, Xw(s2)+Dw(s2)) to the broker server. The broker server verifies the received hashes and, if all the values are correct, returns Hd(s1, Xd(s1)+Dd(s1)) and Hd(s2, Xd(s2)+Dd(s2)), otherwise returns a rejection message. This means that the withdrawal hash is used also to perform client authentication. Finally, the broker server and the user update the structure instances of the electronic wallets s1 and s2 in accordance with the transaction result. Namely, Xd(s1), Xw(s1), Hd(s1, Xd(s1)) and Hw(s1, Xw(s1)) are updated by Xd(s1)+Dd(s1), Xw(s1)+Dw(s1) Hd(s1, Xd(s1)+Dd(s1)) and Hw(s1, Xw(s1)+Dw(s1)), and Xd(s2), Xw(s2), Hd(s2, Xd(s2)) and Hw(s2, Xw(s2)) are updated by Xd(s2)+Dd(s2), Xw(s2)+Dw(s2), Hd(s2, Xd(s2)+Dd(s2)) and Hw(s2, Xw(s2)+Dw(s2)).

(3) Practical Transaction Example

Unlike the example 1, the transfer certificate cannot be used in the case of the example 2. Accordingly, the procedure of transferring electronic money is slightly different from that of the example 1. In what follows, the payment example at an online shop will be explained with reference to FIG. 34.

After confirming the amount v of payment (transfer amount), the user transmits the payer's information, i.e., the serial number s1 of the payer electronic wallet, Xw(s1), Xd(s1), an increment Dw(s1) of Xw(s1) and an increment Dd(s1) of Xd(s1) to the server of the online shop in step i), where v=Dw(s1)*Ww−Dd(s1)*Wd−f.

The online shop then transmits the serial number s2 of the payee electronic wallet, Xw(s2), Xd(s2), an increment Dw(s2) of Xw(s2), and an increment Dd(s2) of Xd(s2) to the broker server together with the received payer's information as an electronic money transfer request in step ii), where v=Dd(s2)*Wd−Dw(s2)*Ww.

The broker server checks the received transfer request in accordance with the above protocol, and returns a transfer request acceptance message ACK if the request is justifiable in step iii). The online shop then transfers the received transfers request acceptance message ACK to the user in step iv).

In response to this, the user transmits Hw(s1, (Xw(s1)+Dw(s1)) to the online shop as payment in step v). The online shop transmits the received hashes to the broker server together with Hw(s2, (Xw(s2)+Dw(s2)) in step vi).

The broker server verifies the received withdrawal hashes and, if verified, transfers electronic money by returning Hd(s1, Hd(s1)+Dd(s1)) and Hd(s2, Hd(s2)+Dd(s2)) in step vii), followed by updating the records of the electronic wallets. The online shop then returns Hd(s1, Hd(s1)+Dd(s1)) to the user as the change in step viii).

(4) Using Electronic Money at Real Shop

The electronic money can be used at a real shop in the same manner as the example 1. First, an electronic wallet is installed in a cellular phone as well as the necessary application. If it is necessary to improve the security against the risk of loss, theft and so forth, the original hash is not saved in the cellular phone, but printed as QR code on paper which is kept in a real wallet and captured by the camera of the cellular phone when necessary. In this case, if the electronic wallet contains a large amount of electronic money, it is possible to carry only part of the electronic money by printing QR code of hashes corresponding to the necessary amount.

The user inputs the payment amount by the use of QR code attached to the commodity or manually inputting the price. The withdrawal hashes are calculated in correspondence with the payment amount, and transmitted to the shop server as electronic money together with the shop ID and the serial number. The shop server receives the withdrawal hashes, and transfer the electronic money to own electronic wallet. If the electronic money has been successfully transferred, a payment number is transmitted to the user and the shop.

Accordingly, after the payment amount is calculated at the register, the user can finish making payment only by verbally giving the payment number to the shop clerk instead of paying real cash. The serial number may be used to more exactly identify the payer. Also, if there is miscalculation, real cash can be used to balance the account.

3. Implementation Example

(1) Deposit Hash Management by Broker Server

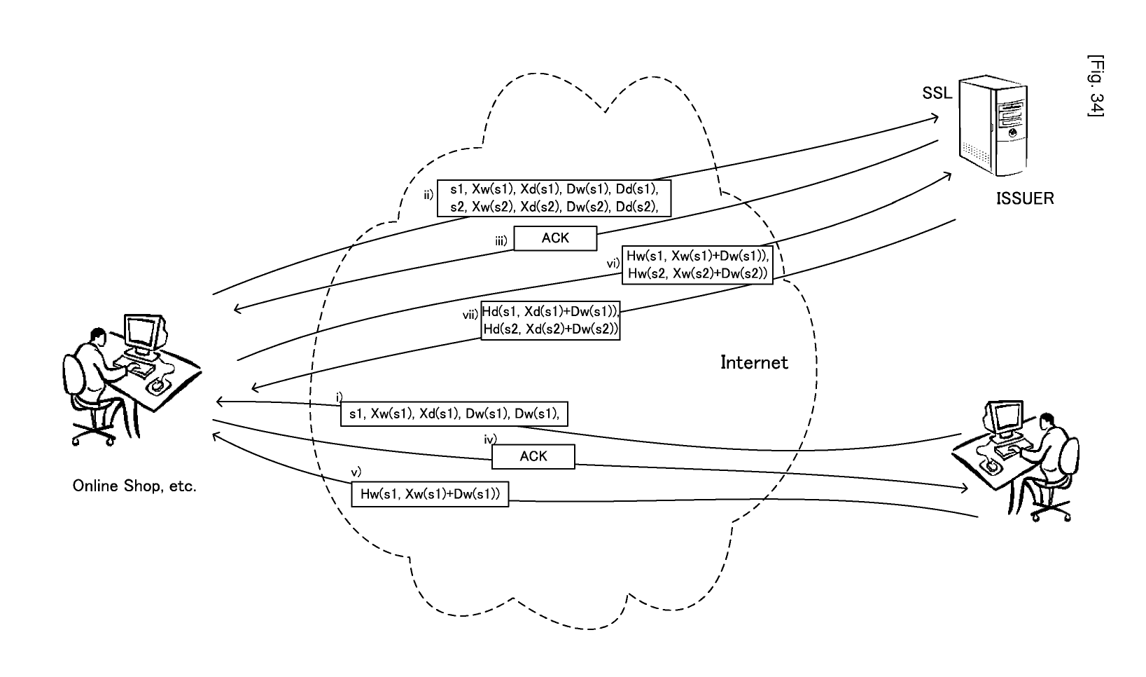

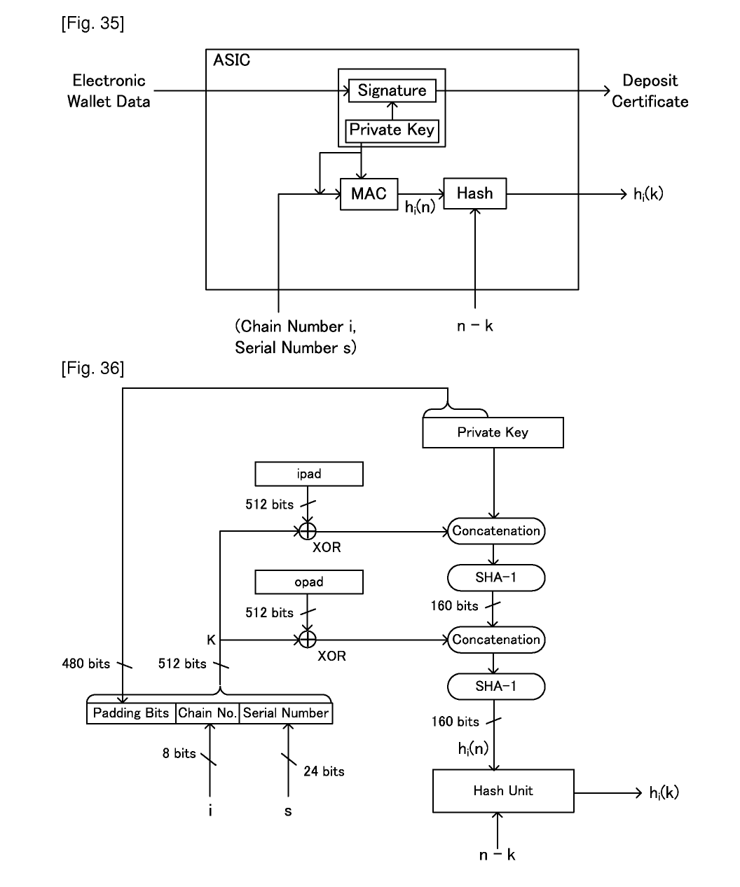

FIG. 35 is a schematic diagram for showing a security chip (TPM: Trusted Platform Module) which is customized for use in the broker server of this example. This chip is provided with a random generator to generate and save a private key within the chip. The above broker signature is provided with this private key in the chip.

This chip has a significant feature different than usual security chips in that the private key is used as part of input data to a MAC unit. Generally speaking, a MAC unit receives a message and a key as input data and outputs a tag (MAC: Message Authentication Code). An entirely-different tag is output even if one different bit is input as the input data.

In this case, the MAC unit receives, as a key, the serial number s of the electronic wallet and the ordinal number of one element Hdᵢ(s) of the deposit hash chain (for example, in the case of the above example, the ordinal number of the hash chain corresponding to a weight of 10 is 0, the ordinal number corresponding to a weight of 100 is 1, and the ordinal number corresponding to a weight of 1000 is 2). This ordinal number is referred hereinbelow to as the chain number. On the other hand, the private key is input as a message.

First, when receiving a request to generate an electronic wallet, deposit root hashes are provided. Specifically, the serial number s and the chain number of 0 are input to the MAC unit of FIG. 35 to output a tag which is used as the n-th hash (n: hash length), i.e., the original hash of the 0-th deposit hash chain corresponding to the serial number s, i.e., Hd₀(s, n). The root hash of the 0-th deposit hash chain can be obtained by recursively processing this hash “n” times. All the root hashes of the deposit hash chain vector Hd(s) can be obtained by repeating this process while incrementing the chain number.

Then, the electronic wallet information is generated with the initial deposit index vector, the initial deposit hashes, the serial number and the received withdrawal root hashes, and signed with the private key to provide a certificate of the broker server. As a result, on the broker server side, it is possible to contract the secret information relating to the deposit hashes of all the electronic wallets to a single private key.

When it is required to calculate the k-th hash of the i-th deposit hash chain corresponding to the serial number s, i.e., Hdᵢ(s, k), this hash can be calculated as follows. Namely, the serial number s and the chain number i are input to the chip of FIG. 35 in which the tag output from the MAC unit is recursively hashed the required number of times, i.e., (n−k) times. There are advantages, in this system, that the broker server need not manage secret information about deposit hashes, and that the load on the broker server can be lessened by performing hash calculation in the chip.

FIG. 36 shows an example of the internal structure of the MAC unit. This is a well-known implementation of the MAC circuit capable of outputting HMAC (Keyed-Hashing for Message Authentication Code). In this case, the serial number s and the chain number i are concatenated together with part of the private key (upper 480 bits) as padding to form a 512-bit key. HMAC generation process is then performed by the use of this 512-bit key and the private key as a message. In FIG. 36, ipad and opad are 64 repetitions of the bytes 0x36 and 0x5c respectively. The HMAC can be calculated with “K” as the 512-bit key and “PrivateKey” as the private key in accordance with the following well-known equation. SHA-1 is a hash function.

HMAC=SHA-1(K XOR opad, SHA-1(K XOR ipad, PrivateKey))

Incidentally, there are considered various methods of generating the key and message from the serial number s, the chain number i and the private key for use in generating a MAC. Also, the above process can be implemented without using a customized TPM but by a software implementation.

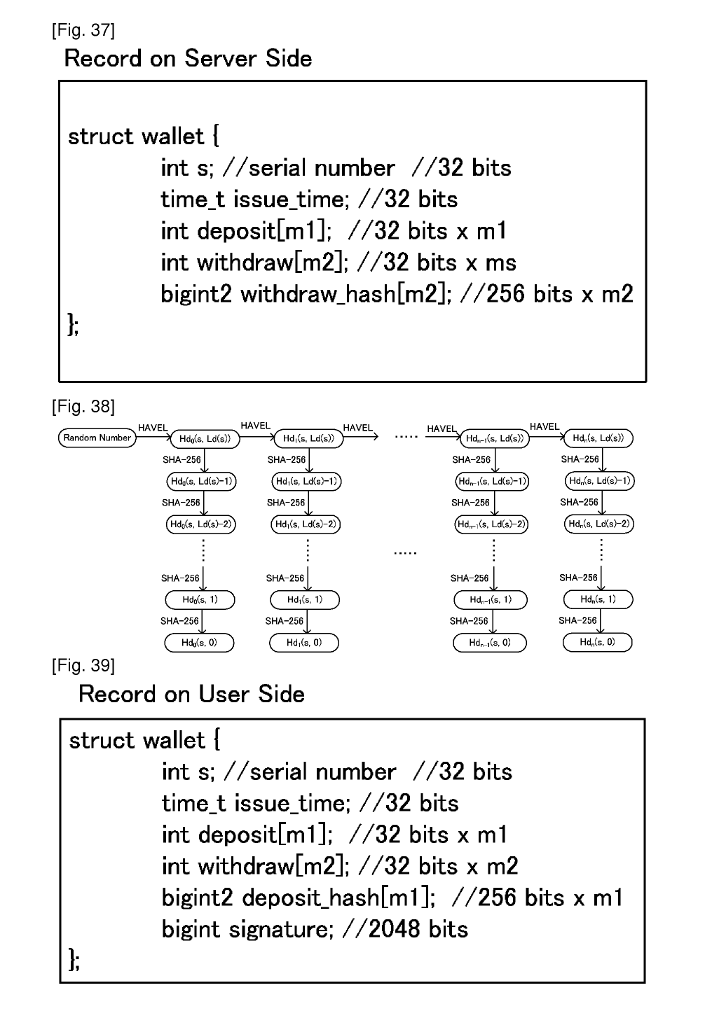

In this case, the broker server manages the record of each user as the instance of the structure illustrated in FIG. 37. The structure shown in FIG. 37 does not include deposit_hash[ ] as Hd(s, Xd(s)). This is because, if necessary, the hashes can be calculated from deposit[ ] as Xd(s) and the above original hashes. Also, the structure shown in FIG. 37 does not include the broker signature. This is because, if necessary, the signature can be calculated from the values of other members.

(2) Withdrawal Hash Management By Users

The client system on the user side can be implemented with a usual PC, a cellular phone or any other arbitrary hardware. In this example, the client system is implemented as a software unit of PC.

This client system has to calculate root hashes when an electronic wallet is created. For this purpose, first, a random number is generated by a random generator. In this example, one 256-bit random number is generated as a seed for generating all the hashes. This seed is recursively processed by a hash function (HAVAL in this example) other than the hash function (SHA-256 in this example) which is designated by the system.

Namely, HAVAL hashing the seed is repeated the number of times corresponding to the number of the withdrawal hash chains in order to calculate the original hashes Hd(s, Lw(s)) of the withdrawal hash chains. Each of the original hashes Hw(s, Lw(s)) of the withdrawal hash chains is recursively hashed Lw(s) times by SHA-256 to obtain the root hashes (FIG. 38). As a result, also on the user side, it is possible to contract the secret information relating to all the withdrawal hashes to a single 256-bit random number. In this case, the electronic wallet is managed on the user side as the instance of the structure illustrated in FIG. 39. The structure shown in FIG. 37 does not include withdraw hash[ ] as Hw(s, Xw(s)). This is because, if necessary, the hashes can be calculated from withdraw[ ] as Xw(s) and the above original hashes.

The computational cost required for calculating HAVAL increases as the number of the withdrawal hash chains increases. It is possible to calculate the last hash Hwᵢ(s, Lw(s)) of the i-th deposit hash chain by HAVAL hashing the seed plus i. Alternatively, if the number of the withdrawal hash chains is no larger than the length of the chains, the last hash Hwᵢ(s, Lw(s)) of the i-th deposit hash chain can be calculated by HAVAL hashing the seed after i-bit rotation. Furthermore, one user may use a plurality of electronic wallets given consecutive numbers as an index. The index is used as a wallet number starting from 0. The above seed for each electronic wallet may be calculated by adding the wallet number multiplied with 0x1000 to a single 256-bit common seed. This makes it possible to contract the secret information relating to all the wallets to a single 256-bit common seed.

(3) High-Dimensional Hash Chains

The example 2 is related to electronic money in the form of electronic coins, such that the hashes of an electronic wallet may be used up after repeating transactions many times. This shortcoming can be improved by increasing the hash length. However, if the number of hash calculations increases, the advantage of the example 2 such as a low computational cost becomes compromised.

The capacity of the electronic wallet can be increased without raising the computational cost by increasing the number of dimensions of the hash chain vector, i.e., the number of hash chains. For example, the number of dimensions is increased to 256 (m1=m2=256). As described above, even in this case, the secret information in the broker server is only a private key. Also, the secret information in each user is only a 256-bit random number.

The broker server has to save 256*256 bits (8,192 bytes) per user as used withdrawal hashes. Also, each user has to save 8,192 bytes as deposit hashes. However, the data to be updated for each transaction is only a few hashes of 256 bits (32 bytes).

Since the number of hash chains is increased, the hash lengths can be short. For example, if the hash length is 16, the index can consist of 4 bits. In this case, the number of bits required of either the deposit or withdrawal index vector is 4*256 bit, i.e., 1024 bits (128 bytes).

The information needed for each transaction is only the chain number, index and number of hashes for each chain to be used, so that the entirety of an index vector need not be transmitted. The chain number (1 byte), index (4 bits) and number of hashes (4 bits) can be represented by 2-byte information in total. Accordingly, for each transaction, the information to be transmitted is approximately 34 bytes per hash chain.

256 hash chains may include, for example, 100 chains having weights of from 10 yen to 1,000 yen at 10-yen intervals, 90 chains having weights of from 1,100 yen to 10,000 yen at 100-yen intervals, and 66 chains having weights of from 11,000 yen to 76,000 yen at 1,000-yen intervals. In this case, if the hash length is 16, a maximum of about 100 million yen can be withdrawn from and deposited into one electronic wallet. By this configuration, it is possible to realize improved usability close to the balance controlled electronic money as discussed above without raising the computational cost.

4. Exemplary Modification

(1) Reducing Computational Burden on Broker Server

In the above example, as change, deposit hashes may be transferred to the payer electronic wallet, and withdrawal hashes may be transferred to the payee electronic wallet. This is for the purpose of reducing the hash consumption of the electronic wallet, in the same manner as 910 yen is paid by paying 1,010 yen and receiving a change of 100 yen.

However, the calculation of deposit hashes increases the computational burden on the broker server. It is possible to receive assistance from users by setting transfer charges in proportion to the computational cost required of the broker server for calculating hashes.

(2) Using Withdrawal Hash Alone

It is possible to omit the deposit hashes from the above system. For example, the broker server is operated by a shopping mall such that payment can be made by withdrawal hashes. Even in this case, while the electronic money is simply of a prepaid type, the server can have evidence for used electronic money, and the user can prove the ownership of electronic money only on the basis of the local data. Accordingly, the electronic money issuer is released or absolved from the responsibility of keeping and protecting the electronic money itself issued and delivered to the user in the same manner as a bank is absolved from the responsibility of keeping and protecting the issued bank note.

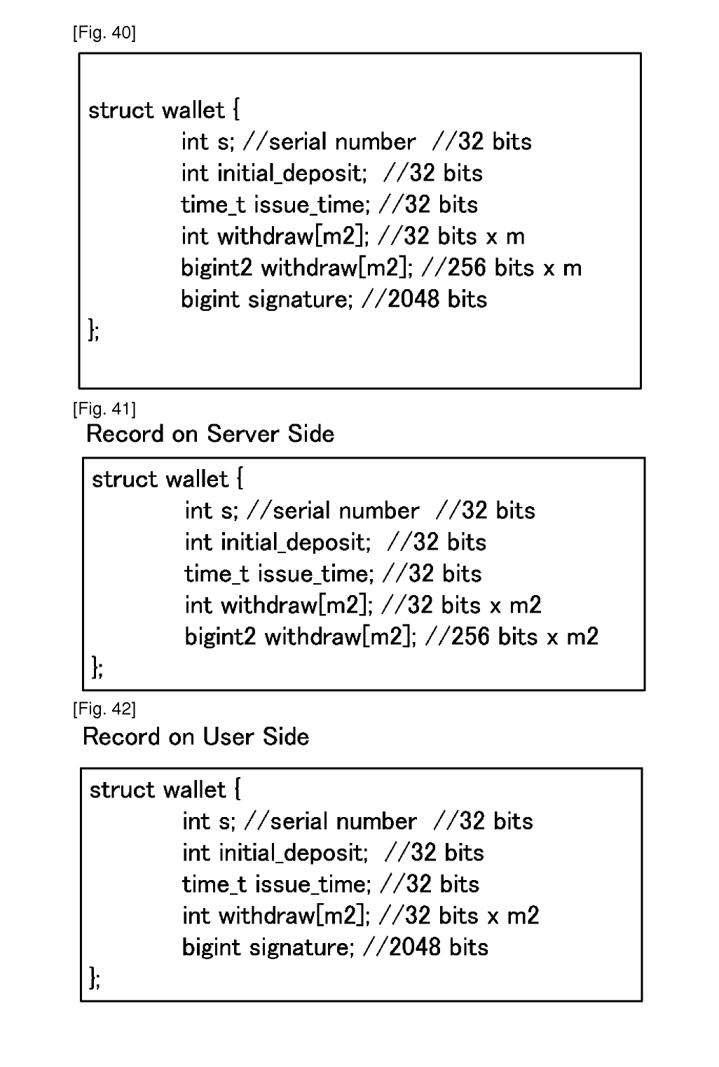

In this case, the electronic wallet structure is defined as shown in FIG. 40. The amount of electronic money stored in a new electronic wallet is set initially to the member “initial_deposit”, and monotonically decreasing as consuming withdrawal hashes. The broker server manages the record of each user as the instance of the structure illustrated in FIG. 41. Also, the electronic wallet is managed on the user side as the instance of the structure illustrated in FIG. 42.

### INDUSTRIAL APPLICABILITY

As has been discussed above, the service providing method according to the present invention can be applied to the transactions between a service provider and users with high reliability.

### REFERENCE SIGNS LIST

1 electronic money process server
2 issuer server
3 proxy signing server
4 communication unit
5 storage device
6 request processing unit
7 storage device
8 HSM (hardware security module)
9 transfer processing unit
11 communication unit
12 signature unit
13 verification unit
14 encryption key generation unit
15 private key storing unit
16 electronic wallet structure storing unit
17 processing control unit

1. A method of providing a service from a service provider to users comprising:
a step of receiving a first information item and provided by a user by an information receiving device;
a step of generating a first electronic signature on the first information item with a private key of the service provider by the use of an information processing device and providing the first electronic signature to the user,
a step of receiving a request for the service together with information identifying the first information item from a user and accepting this request if it is justifiable;
a step of receiving, if the request is accepted, a second information item transmitted from the user by an information receiving device;
a step of determining whether or not there is a predetermined relationship between the first information item and the second information item by the use of an information processing device; and
a step of performing, if there is the predetermined relationship, a necessary procedure for providing the service by the use of an information processing device; and
a step of saving the second information item even after providing the service as an evidence that the service has been provided,
wherein the request for the service is judged that it is not justifiable in the case where the second information item identified by the information which is received together with this request has been received and saved, and the service has already been provided,
wherein, from the viewpoint of the current information processing technology, it is considered generally impossible to generate information having the predetermined relationship with the first information item in advance of knowing the second information item.

2. The method of claim 1 wherein
the first electronic signature is generated on a specification of the service including the first information item with the private key of the service provider.

3. The method of claim 2 wherein
a first instance of the first information item includes a first public key;
it is judged that the request for the service is justifiable if the specification and the second information item previously saved accord with the request for the service;
the second information item contains an acknowledgement that the service has been received and a second electronic signature; and
the predetermined relationship is such that the second electronic signature can be successfully verified on the acknowledgement with a first public key.

4. The method of claim 3 wherein
the service is provided to allow the user to use an amount of electronic money in a first electronic wallet which is associated with the first public key;
the specification about the service contains the cumulative total of deposited amounts of the electronic money in the first electronic wallet;
the acknowledgement admits the cumulative total of withdrawn amounts of the electronic money in the first electronic wallet incremented corresponding to the used amount of electronic money.

5. The method of claim 4 wherein
the balance of the electronic money corresponds to the difference between the cumulative total of deposited amounts contained in the first information and the cumulative total of withdrawn amounts admitted in the acknowledgement;
the request for the service contains information about an amount of the electronic money to be used;
the request for the service is judged that it is not justifiable if the cumulative total of deposited amounts contained in the first information is not sufficient for the amount of the electronic money to be used in relation to the cumulative total of withdrawn amounts admitted by the acknowledgement contained in the second information previously saved.

6. The method of claim 5 wherein
the service is provided to allow the user to transfer an amount of the electronic money from the first electronic wallet to a second electronic wallet which is associated with a second public key;
the request for the service contains information about the second electronic wallet and the amount to be transferred;
when transferring the amount to be transferred, the service provider generates an electronic signature with the private key of the service provider on a second instance of the first information item which includes the second public key and a specification about the service containing the cumulative total of deposited amounts in the second electronic wallet which is incremented by the amount to be transferred.
